(19) United States
(12) Patent Application Publication
(10) Pub. No.: US 2011/0010778 A1
(43) Pub. Date: Jan. 13, 2011

(54) STANDALONE SOLUTION FOR SERIAL COPY MANAGEMENT SYSTEM (SCMS) COMPLIANCE

(76) Inventor: Hank RISAN, Santa Cruz, CA (US)

Correspondence Address: MEDIA RIGHTS TECHNOLOGIES C/O WAGNER BLECHER LLP, 123 WESTRIDGE DRIVE, WATSONVILLE, CA, 95076, US

(21) Appl. No.: 12/500,534

(22) Filed: Jul. 9, 2009

(51) Int. Cl. G06F 21/24

(52) U.S. Cl. 726/30; 726/26

(57) ABSTRACT

Standalone serial copy management system (SCMS) compliance with respect to distributing and receiving protected digital media is disclosed. In general, when a digital media file is selected for transfer or reception between a computing system and another device, serial copy management system copy/playback information for the digital media file is accessed. If the serial copy management system copy/playback information comprises unrestricted copy/playback information the SCMS may utilize a common transfer pathway for the transfer or reception. However, if the serial copy management system copy/playback information comprises controlled copy/playback information the SCMS utilizes a new pathway distinct from said common transfer pathway for the transfer or reception of digital media, providing complete copyright protection from point of entry. In so doing, standalone SCMS compliance uses technological measures that effectively control access to the copyright protected work, as described in 17 U.S.C. sections 1201, 1202 and 1001.

### FIELD

Embodiments of the present technology relates generally to the field of media rights protection.

### BACKGROUND

Presently, if a user wants to buy a particular song or video, the media can be purchased and downloaded from the Internet. For example, an end user can upload media or access any of a number of media distribution sites, purchase and download the desired media and then listen or watch the media repeatedly.

In many cases, the media being purchased and downloaded will include some type of copyright protection. Basically, the copyright protection allows the owner of the copyrighted media to control distribution of the media and receive the proper copyright royalties for the use of the copyright protected media. For example, if the downloaded media is copyright protected, copyright royalties may be required by anyone copying, transmitting or subsequently downloading the protected media.

Presently, there are a number of applications that attempt to circumvent the copyright protection. Under Title 17, the copyright owner has legal standing to require media distributors to protect the copyrighted material with technological measures.

### SUMMARY

Standalone serial copy management system (SCMS) compliance with respect to distributing and receiving protected digital media is disclosed. In general, when a digital media file is selected for transfer or reception between a computing system and another device, serial copy management system copy/playback information for the digital media file is accessed. If the serial copy management system copy/playback information comprises unrestricted copy/playback information the SCMS may utilize a common transfer pathway for the transfer or reception. However, if the serial copy management system copy/playback information comprises controlled copy/playback information the SCMS utilizes a new pathway distinct from said common transfer pathway for the transfer or reception of digital media, providing complete copyright protection from point of entry.

One embodiment of the present technology described herein provides a standalone solution for SCMS compliance that provides complete protection of digital media from point of entry. In one embodiment, standalone SCMS compliance uses technological measures to effectively control access to the copyright protected work, as described in 17 U.S.C. sections 1201, 1202 and 1001. That is, the standalone SCMS acts as a technological measure which “effectively controls access to a work” by requiring the application of information, with the authority of the copyright owner, to gain access to the work.

In one embodiment, the standalone solution for SCMS compliance described herein begins providing protection based on the copyright management information for a digital media work at the time the digital media enters the SCMS system. In addition, once the digital media enters the standalone solution for SCMS compliance, the present technology not only maintains the digital media in a playback and copy controlled environment but also actively monitors the digital media, including authorized copies thereof, for removal or alteration of lawful copyright management information.

In other words, when a usage controlled media file is placed into the standalone solution for SCMS compliance system, either by a service (such as an Internet based media provider or the like) or an individual utilizing various media types, such as, but not limited to, CD, DVD, memory storage devices, handheld media players, networked devices, etc. the disclosed framework begins to provide ongoing transfer, playback and copying protection. Additionally, embodiments described herein continue to provide the playback and copying protection of the digital media regardless of whether the digital media is transcoded, uploaded or downloaded.

### BRIEF DESCRIPTION OF THE DRAWINGS

FIG. 1 is a block diagram of various exemplary functional components of a copyright compliance mechanism (CCM) in accordance with an embodiment of the present invention.

FIG. 2 is a block diagram of a custom media library utilized to secure digital media content, in accordance with an embodiment of the present technology

FIG. 3 is a block diagram of a system for enhancing copyright revenue generation, in accordance with an embodiment of the present invention.

FIG. 4 is a block diagram of a flow chart of a method for enhancing copyright generation, in accordance with an embodiment of the present invention.

FIG. 5 is a block diagram of a flow chart of a method for determining if secure media copying of digital media content in a usage protected frame-based work is allowed, in accordance with an embodiment of the present invention.

FIG. 6 is a block diagram of a flow chart of a method for secure media copying of digital media content in a usage protected frame-based work, in accordance with an embodiment of the present invention.

FIG. 7 is a block diagram of a copyright compliance mechanism/media storage device (CCM/MSD) adapted to be disposed on a media storage device, in accordance with an embodiment of the present invention.

FIG. 8 is a block diagram of an exemplary computing environment shown in accordance with an embodiment of the present invention.

FIG. 9 is a data flow block diagram of an exemplary method for providing a media change notification on a computing system in accordance with an embodiment of the present invention.

FIG. 10 is a flowchart of a method for automatically executing an operation after a media event in accordance with an embodiment of the present invention.

FIG. 11 is a data flow block diagram for automatically detecting media and implementing interaction control thereon, in accordance with an embodiment of the present invention.

FIG. 12 is a flowchart of a method for automatically detecting media and implementing interaction control thereon in accordance with another embodiment of the present invention.

FIG. 13 is a block diagram of a standalone solution for SCMS compliance when locally stored digital media data is transferred from a computing system is shown in accordance with one embodiment.

FIG. 14 is a block diagram of a standalone solution for SCMS compliance when digital media data is received to a computing system is shown in accordance with one embodiment.

FIG. 15 is a block diagram of an exemplary computer system in accordance with one embodiment of the present invention.

FIG. 16 is a block diagram of an exemplary system that may be used for protecting copyrighted media with monitoring logic and/or may be used for reporting information about users who illegally obtain copyrighted media, shown in accordance with one embodiment.

FIG. 17 is a flowchart for reporting information about users who obtain copyrighted media illegally using a network shown in accordance with one embodiment.

FIG. 18 is a flowchart for protecting copyrighted media using monitoring logic that detects the presence of copyrighted media on a user's computer, shown in accordance with one embodiment.

FIG. 19 is a block diagram of a system that uses watermarking techniques to prevent users from circumventing monitoring logic, shown in accordance with one embodiment.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview

According to 17 U.S.C. 106 and 114, an owner of copyright in a sound recording has exclusive rights to the sound recording. Copyright law also requires a plurality of copyright royalties paid to the copyright owner for the use of copyrighted work, such as but not limited to performance royalties and publishing royalties. The royalty rates are set by the Copyright Royalty Board. In order for a copyright owner to enforce and collect copyright royalties, the copyright owner must have a valid copyright that is registered with the United States Copyright Office. A way to protect a copyright protected work and ensure payment of copyright royalties is through the use of technological measures that effectively control access to the copyright protected work, as described in 17 U.S.C. sections 1201, 1202 and 1001. Thus, the copy management information acts as a technological measure which “effectively controls access to a work” by requiring the application of information, with the authority of the copyright owner, to gain access to the work.

One embodiment of the present technology described herein provides a standalone solution for SCMS compliance that provides complete protection of digital media from point of entry. Moreover, the standalone solution for SCMS compliance described herein begins providing protection based on the copyright management information for a digital media work at the time the digital media enters the SCMS system. In addition, once the digital media enters the standalone solution for SCMS compliance, the present technology not only maintains the digital media in a playback and copy controlled environment but also actively monitors the digital media, including authorized copies thereof, for removal or alteration of lawful copyright management information.

In other words, when a usage controlled media file is placed into the standalone solution for SCMS compliance system, either by a service (such as an Internet based media provider or the like) or an individual utilizing various media types, such as, but not limited to, CD, DVD, memory storage devices, handheld media players, networked devices, etc. the disclosed framework begins to provide ongoing playback and copying protection. Additionally, embodiments described herein continue to provide the playback and copying protection of the digital media regardless of whether the digital media is transcoded, uploaded or downloaded.

For example, if a user provides a CD containing protected digital media to a computing system and the digital media on the CD is converted to a wave file, transcoded to an MP3 and uploaded to the same user's handheld media player. The present technology reviews the protection of the digital media throughout the process to ensure the processes conform to importation, manufacture and distribution law. Specifically, that the standalone solution for SCMS compliance system accurately sends, receives and acts upon copyright and generation status information during the playback, storage, transcoding, uploading and or downloading of the protected digital media. Thus, in one embodiment, the standalone solution for SCMS compliance is capable of monitoring every operation performed by an application that involves a file, volume, or device containing copy and/or playback control information.

Thus, in one embodiment, the standalone solution for SCMS compliance is capable of managing all forms of SCMS information, including information that may or may not be embedded directly within a particular file, volume or device. Even if such information is supported, there may or may not be a mechanism to update this information to reflect the status of the operation (in the case where the entity supported a limited number of copies or plays). An example of this is a read-only medium such as a CD-ROM, for which the SCMS information could not be modified directly on the medium itself. Also, there may be some file, volume, or device types for which the SCMS information is implied in nature, such as for the copyrighted video content on a commercial DVD.

Furthermore, in one embodiment, the standalone solution for SCMS compliance is able to manage all of the means of access to SCMS-controlled resources including applications that use SCMS-controlled volumes, devices, and files can do so in a number of ways, which include (but again are not limited to) publicly accessible APIs that are documented for the operating system, undocumented APIs, supplemental APIs that use alternate data pathways within a system, lower-level APIs (including those for services at the kernel level), and in some cases, the data bus or the physical hardware itself.

Finally, the standalone solution for SCMS compliance is also capable of monitoring multiplicity of potential data transfer techniques available to the computing system to ensure SCMS compliance. In general, the multiplicity of potential data transfer types include, but is not limited to, file-to-file copy, file-to-rendering-device playback, network-to-file download, and an external-device-to-network upload operation that does not touch the local file system.

The present discussion of the method and system for a standalone solution for SCMS compliance utilizes a plurality of modules and applications to ensure the protection of the digital media. The discussion begins with a description of a copyright compliance mechanism (CCM) module that is utilized on the user system for controlling distribution of, access to, and/or copyright compliance of media files including preventing a copyright-disregarding recording application from establishing a system hook for the purpose of generating an illegal copy of the copyright media. A custom media library incorporated into the user system in conjunction with the CCM module is then described. A component for enhancing of copyright revenue generation by facilitating in the ensuring of appropriate payment of entitled copyright royalties, as well as a module for embedding copyright and playback management information into at least one data field of the copyright protected frame-based work is then discussed.

The discussion of the standalone solution for SCMS compliance also includes a module for determining if secure media copying and/or playback (C/P) of digital media content in a usage protected frame-based work is allowed as well as a method for performing the secure media copying or playback of the digital media content utilizing the usage protected frame-based work. In addition, in one embodiment, the standalone solution for SCMS compliance includes an autorun protocol component for invoking automatic installation of CCM. To deter users from attempts at defeating various features inherent to CCM, (e.g., the autorun feature), a CCM monitoring program, verifies that those features that are to be operational are operational, and if not, CCM prohibits the user from experiencing the contents of the media storage device.

### Copyright Compliance Mechanism (CCM)

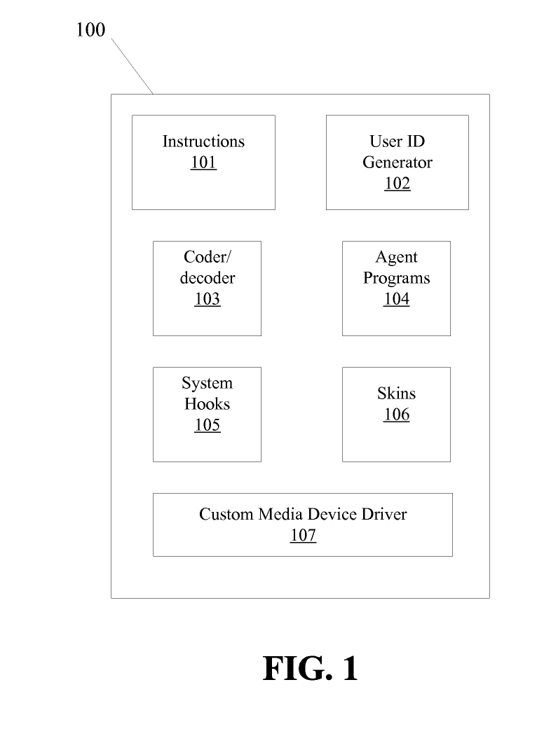

With reference now to FIG. 1, a block diagram of an exemplary copyright compliance mechanism (CCM) 100, for controlling distribution of, access to, and/or copyright compliance of media files, in accordance with an embodiment of the present invention. In one embodiment, CCM 100 contains one or more software components and instructions for enabling compliance with DMCA (digital millennium copyright act) restrictions and/or RIAA (recording industry association of America) licensing agreements regarding media files. In one embodiment, although copyright is used in the description, another type of usage protection including copy, transfer or playback limitations may also be utilized within the framework described herein. In other words, in one embodiment, the present technology is well suited for numerous types of usage protection including, but not limited to, copyright protection. In general, the usage protection allows the owner of the usage restricted media to control distribution of the media.

There are currently two types of copyright licenses recognized by the DMCA for the protection of broadcasted copyrighted material. One of the broadcast copyright licenses is a compulsory license, also referred to as a statutory license. A statutory license is defined as a non-interactive license, meaning the user cannot select the song. Further, a caveat of this type of broadcast license is that a user must not be able to select a particular music file for the purpose of recording it to the user's computer system or other storage device. Another caveat of a statutory license is that a media file is not available more than once for a given period of time. In one example, the period of time can be three hours.

The other type of the broadcast license recognized by the DMCA is an interactive licensing agreement. An interactive licensing agreement is commonly with the copyright holder, e.g., a record company, the artist, where the copyright holder grants permission for a server to broadcast copyrighted material. Under an interactive licensing agreement, there are a variety of ways that copyrighted material, e.g., music files, can be broadcast. For example, one manner in which music files can be broadcast is to allow the user to select and listen to a particular sound recording, but without the user enabled to make a sound recording. This is commonly referred to as an interactive with “no save” license, meaning that the end user is unable to save or store the media content file in a relatively permanent manner. Additionally, another manner in which music files can be broadcast is to allow a user to not only select and listen to a particular music file, but additionally allow the user to save that particularly music file to disc and/or burn the music file to CD, MP3 player, or other portable electronic device. This is commonly referred to as an interactive with “save” license, meaning that the end user is enabled to save, store, or burn to CD, the media content file.

It is noted that the DMCA allows for the “perfect” reproduction of the sound recording. A perfect copy of a sound recording is a one-to-one mapping of the original sound recording into a digitized form, such that the perfect copy is virtually indistinguishable and/or has no audible differences from the original recording.

In one embodiment, CCM 100 is installed into each client computer system. Alternatively, CCM 100 can be, in another embodiment, externally disposed and communicatively coupled with a client computer system. In one embodiment, portions of components, entire components and/or combinations of components of CCM 100 can be readily updated to reflect changes or developments in the DMCA, changes or developments in copyright restrictions and/or licensing agreements that pertain to any media file, changes in current media player applications and/or the development of new media player applications.

Referring to FIG. 1, in one embodiment, CCM 100 is shown to include instructions 101 for enabling a client computer system to interact with a web server or content server on a network. CCM 100 also includes, a user ID generator 102, for generating a user ID or user key, and one or more cookie(s) which contain(s) information specific to the user and the user's computer system. In one embodiment, the presence of a valid cookie(s) and a valid user ID/user key are verified by a web server before the remaining components of a CCM 100 can be installed. Additionally, the user ID/user key can contain, but is not limited to, the user's name, the user's address, the user's credit card number, verified email address, and an identity (username) and password selected by the user. Furthermore, the cookie can contain, but is not limited to, information specific to the user, information regarding the user's computer system, e.g., media applications thereon, a unique identifier such as a MAC (machine address code) address and/or an IP address, and other information specific to the user and the computer system operated by the user. The information regarding the client computer system, the user of the system, and an access key described herein can be collectively referred to as authorization data.

Advantageously, with information regarding the user and the user's computer system, a web server can determine when a user of one computer system has given their username and password to another user using another computer system. If the web server detects unauthorized sharing of usemames and passwords, it can block the computer system from future access to copyrighted media content available through the web server for any specified period of time, e.g., for a matter of minutes or hours to months, years, or longer.

Still referring to FIG. 1, CCM 100 further includes one or more coder/decoders (codec) 103 that, in one embodiment, is/are adapted to perform, but is/are not limited to, encoding/decoding of media files, compressing/decompressing of media files, detecting that delivered media files are encrypted as prescribed by CCM 100. In the present embodiment, coder/decoder 103 can also extract key fields from a header attached to each media content file for, in part, verification of the media file. In one embodiment, codec 103 can also perform a periodic and repeated check of the media file, while the media file is passed to the media player application, e.g., in a frame by frame basis or in a buffer by buffer basis, to ensure that CCM 100 rules are being enforced at any particular moment during media playback. It is noted that differing codec 103 can be utilized in conjunction with various types of copyrighted media content including, but not limited to, audio files, video files, graphical files, alphanumeric files and the like, such that any type of media content file can be protected in accordance with embodiments of the present invention.

With reference still to FIG. 1, CCM 100 also includes one or more agent programs 104 which are configured to engage in dialogs and negotiate and coordinate transfer of information between a computer system, a server, and/or media player applications, with or without recording functionality, that are operable within a client computer system. In addition, agent program 104 can be configured to maintain system state, verify that other components are being utilized simultaneously, to be autonomously functional without knowledge of the client, and can also present messages, e.g., error messages, media information, advertising, etc., via a display window or electronic mail. This enables detection of proper skin implementation and detection of those applications that are running. It is noted that agent programs are well known in the art and can be implemented in a variety of ways in accordance with the present embodiment.

CCM 100 also includes one or more system hooks 105. A system hook 105 is, in one embodiment, a library that is installed in a computer system and intercepts system wide events. For example, a system hook 105, in conjunction with skins 106, can govern certain properties and/or functionalities of media player applications operating within the client computer system, including, but not limited to, mouse click shortcuts, keyboard shortcuts, standard system accelerators, progress bars, save functions, pause functions, rewind functions, skip track functions, forward track preview, copying to CD, copying to a portable electronic device, and the like.

It is noted that the term governing, can refer to a disabling, deactivating, enabling, activating, etc., of a property or function. Governing can also refer to an exclusion of that function or property, such that a function or property may be operable but unable to perform in the manner originally intended. For example, during playing of a media file, the progress bar may be selected and moved from one location on the progress line to another without having an effect on the play of the media file.

In one embodiment, system hook 105 compares the information for the media player application operating in client computer system with a list of “signatures” associated with known media recording applications. In one embodiment, the signature can be, but is not limited to being, a unique identifier of a media player application and which can consist of the window class of the application along with a product name string which is part of the window title for the application. Advantageously, when new media player applications are developed, their signatures can be readily added to the signature list via an update of CCM 100 described herein.

The following C++ source code is exemplary implementation of the portion of a system hook 105 for performing media player application detection, in accordance with an embodiment of the present invention.

int
IsRecorderPresent(TCHAR * szAppClass,

| | |
|---|---|
| TCHAR * | szProdName) |

{

| | |
|---|---|
| TCHAR | szWndText[_MAX_PATH]; /* buffer to receive title string for |

window */

| | | |
|---|---|---|
| HWND | hWnd; | /* handle to target window for operation */ |

| | | |
|---|---|---|
| int | nRetVal; | /* return value for operation */ |

/* initialize variables */
nRetVal = 0;
if ( _tcscmp(szAppClass, _T(“#32770”))
== 0)
{

/* attempt to locate dialog box with specified window title */
if ( FindWindow((TCHAR *) 32770, szProdName)
!= (HWND) 0)
{

/* indicate application found */
nRetVal = 1;

}

}
else
{

/* attempt to locate window with specified class */
if ( (hWnd = FindWindow(szAppClass, (LPCTSTR) 0))
!= (HWND) 0)
{

/* attempt to retrieve title string for window */
if ( GetWindowText(hWnd,

szWndText,
_MAX_PATH)

!= 0)
{

/* attempt to locate product name within title string */
if ( _tcsstr(szWndText, szProdName)
!= (TCHAR *) 0)
{

/* indicate application found */
nRetVal = 1;

}

}

}

}
/* return to caller */
return nRetVal;

}

In one embodiment, system hook 105 can also selectively suppress waveform input/output operations to prevent recording of copyrighted media on a client computer system. For example, system hook 105, subsequent to detection of bundled media player applications operational in a client computer system can stop or disrupt the playing of a media content file. This can be accomplished, in one embodiment, by redirecting and/or diverting certain data pathways that are commonly used for recording, such that the utilized data pathway is governed by CCM 100. This can be performed within a driver shim for a standard operating system waveform output device. Moreover, the driver shim may be configured to appear as the default waveform audio device to client level application programs. Thus, requests for processing of waveform audio input and/or output will pass through the driver shim prior to being forwarded to the actual waveform audio driver. Such waveform input/output suppression can be triggered by other components of CCM 100, e.g., agent 104, to be active when a recording operation is initiated by a client computer system during the play back of media files which are subject to the DMCA. The driver shim can be implemented for nearly any media in nearly any format including, but not limited to, audio media files and audio input and output devices.

The following C++ source code is an exemplary implementation of the portion of a system hook 105 for diverting and/or redirecting certain data pathways that are commonly used for recording of media content, in accordance with an embodiment of the present invention.

| | |
|---|---|
| DWORD | |
| _stdcall | |
| widMessage(UINT | uDevId, |
| UINT | uMsg, |

| | |
|---|---|
| DWORD | dwUser, |
| DWORD | dwParam1, |
| DWORD | dwParam2) |

{

| | | |
|---|---|---|
| BOOL | bSkip; | /* flag indicating operation to be skipped */ |

| | | |
|---|---|---|
| HWND | hWndMon; | /* handle to main window for monitor */ |
| DWORD | dwRetVal; | /* return value for operation */ |

/* initialize variables */
bSkip = FALSE;
dwRetVal = (DWORD) MMSYSERR_NOTSUPPORTED;
if (uMsg == WIDM_START)
{

/* attempt to locate window for monitor application */
if ( (hWndMon = FindMonitorWindow( ))
!= (HWND) 0)
{

/* obtain setting for driver */
bDrvEnabled = ( SendMessage(hWndMon,

uiRegMsg,

0,
0)

== 0)

? FALSE : TRUE;

}
if (bDrvEnabled == TRUE)
{

/* indicate error in operation */
dwRetVal = MMSYSERR_NOMEM;
/* indicate operation to be skipped */
bSkip = TRUE;

}

}
if (bSkip == FALSE)
{

/* invoke entry point for original driver */
dwRetVal = CallWidMessage(uDevId, uMsg, dwUser, dwParam1,

dwParam2);

}
/* return to caller */
return dwRetVal;

}

When properly configured, system hook 105 can govern nearly any function or property within nearly any media player application that may be operational within a client computer system. In one embodiment, system hook 105 is a DLL (dynamic link library) file. It is further noted that system hooks can be implemented in nearly any operating system.

In FIG. 1, CCM 100 also includes one or more skins 106, designed to be installed in a client computer system. In one embodiment, skins 106 are utilized to assist in client side compliance with the DMCA regarding copyrighted media content. Skins 106 are customizable interfaces that, in one embodiment, are displayed on a display device of computer system and provide functionalities for user interaction of delivered media content. Additionally, skins 106 can also provide a display of information relative to the media content file including, but not limited to, song title, artist name, album title, artist bio, and other features such as purchase inquiries, advertising, and the like.

Furthermore, when system hook 105 is unable to govern a function of the media player application operable on a client computer system such that client computer system could be in non-compliance with DMCA and/or RIAA restrictions, a skin 106 can be implemented to provide compliance.

Differing skins 106 can be implemented depending upon the DMCA and/or RIAA restrictions applicable to each media content file. For example, in one embodiment, a skin 106 may be configured for utilization with a media content file protected under a non-interactive agreement and may not include a pause function, a stop function, a selector function, and/or a save function, etc. In another embodiment, skin 106 may be configured to be utilized with a media content file protected under an interactive “no save” agreement such that skin 106 may include a pause function, a stop function, a selector function, and for those media files having an interactive with “save” agreement, a save or a burn to CD function.

Still referring to FIG. 1, each skin 106 can have a unique name and signature and can be implemented, in part, through the utilization of an MD (message digest) 5 hash table or similar algorithm. An MD 5 hash table can be, in one implementation, a check-sum algorithm. Since modification of the skin would change the check sum and/or MD 5 hash, without knowledge of the MD 5 hash table, changing the name or modification of the skin may simply serve to disable the skin, in accordance with one embodiment of the present invention. Since CCM 100 verifies skin 106, MD5 hash tables advantageously provide a deterrent against skin name changes and/or modifications made thereto.

In one embodiment, CCM 100 also includes one or more custom media device driver(s) 107 for providing an even greater measure of control over the media stream while increasing compliance reliability. A client computer system is configured to utilize a custom media device application, e.g., a custom audio device application, a custom video device application, etc., that is emulated by a custom media device driver 107. With reference to audio media, the emulation is performed in a waveform audio driver associated with a custom audio device. Driver 107 is configured to receive a media file being outputted by the system prior to the media file being sent to a media output device, e.g., a video card for video files or a sound card for audio files, etc. In one embodiment, client computer system is configured with a custom media device driver 107 as the default device driver for media file output. In one embodiment, an existing GUI (graphical user interface) can be utilized or a GUI can be provided, e.g., by utilization of a skin 106 or a custom web based player application, for forcing or requiring the system to have driver 107 as the default driver.

Therefore, when a media content file is received by the system, the media content file is playable, provided the media content file passes through the custom media device application, emulated by custom media device driver 107, prior to being outputted. However, if an alternative media player application is selected, delivered media files will not play on the system.

Thus, secured media player applications would issue a media request to the driver for the custom media device which then performs necessary media input suppression, e.g., waveform suppression for audio files, prior to forwarding the request to the default waveform audio driver for audio files.

It is noted that requests for non-restricted media files can pass directly through custom media device driver 107 to a waveform audio driver operable on the system. It is further noted that for either secured media or non-restricted media, e.g., audio media files, waveform input suppression can be triggered by other components of CCM 100, e.g., agents 104, system hooks 105, and skins 106, or a combination thereof, to be active when a recording operation is initiated simultaneously with playback of secured media files.

Advantageously, by virtue of being configured with a custom media device, emulated by a custom media device driver 107, as the default device driver, those media player applications that require their particular device driver to be the default driver, e.g., Total Recorder, etc., are rendered non-functional for secured music. Further advantageous is that an emulated custom media device provides no native support for those media player applications used as a recording mechanism, e.g., DirectSound capture, etc., that are able to bypass user-mode drivers for most media devices. Additionally, by virtue of the media content being sent through device driver 107, thus effectively disabling unauthorized saving/recording of the media files; media files that are delivered in a secured delivery system do not have to be encrypted to provide compliance with copyright restrictions and/or licensing agreements, although, in another embodiment, they still may be encrypted.

Custom Media library

A subversive and illegal technique for capturing outgoing copyright media data is addressed and overcome herein. Specifically, the present technology stops a copyright-disregarding recording application from establishing a system hook for the purpose of generating an illegal copy of the copyright media. That is, the present technology redirects calls made by secure media playback applications to unsecure standard operating system services used for rendering the raw media data. In so doing, the system hook is no longer able to intercept the raw media data and therefore no longer able to deliver the intercepted data to illicit recording application 290.

Additionally, since the present technology implements a custom media library utilizing a new pathway at the CCM-enabled playback/recording application to circumvent the illegal copying techniques without interfering or disrupting the commonly used pathway, the computer system maintains the capability of delivering media content that may be legally copied to the recording application while protecting copyrighted digital media content from being illegally copied by the same, or another, recording application.

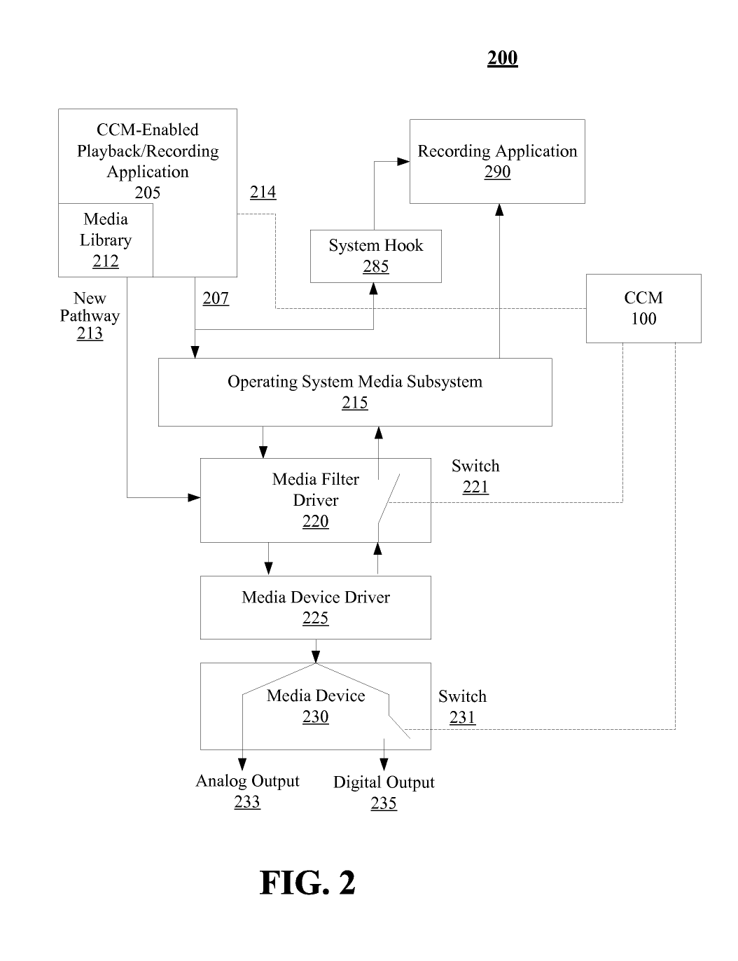

With reference now to FIG. 2, a block diagram of a computer system 200 having a custom media library to secure digital media content is shown in accordance with an embodiment of the present technology. In one embodiment, FIG. 2 includes a number of distinct components and devices for clarity in the discussion. However, in another embodiment, more or fewer components and devices may be present. Further, in yet another embodiment, the components and devices may be combined into one or more components able to perform a number of the actions shown in FIG. 2.

In one embodiment, by utilizing the media library 212 in conjunction with the CCM-enabled playback/recording application 205 and the CCM 100, secure media content may be rendered, played, recorded and copied without the data being in an unsecure environment. In addition, due to the secure environment, in one embodiment no encryption of the media content is necessary.

For example, as illustrated in FIG. 2, when a hooked system service, e.g., OS media subsystem 215, is called, the system hook 285 will gain control of the commonly used pathway 207 first, allowing the recording application 290 to perform application-specific processing before passing control to the actual OS media subsystem 215. The system hook 285 will thus allow the recording application 290 to capture output data without the use of a virtual media device driver or plug-in module.

However, embodiments described herein, overcome this illegal capture technique by incorporating a media library 212 of media functions that make use of lower-level components in the media subsystem, e.g., media filter driver 220, to render secure media data. These lower-level components are not affected by the system hooks 285 that are used by recording applications, and thus copyright protected media can pass securely from the CCM-enabled playback/recording application 205 to a part of the media subsystem, e.g., the media filter driver 220 that is protected by the existing CCM, e.g., CCM 100.

For example, in one embodiment, custom media library 212 provides a secure path for the digital media content as it is delivered from the CCM-enabled playback/recording application 205 to the operating system (OS) media subsystem 215. In one embodiment, media library 212 is able to securely receive the digital media content from the CCM-enabled playback/recording application 205 because it is linked directly into the CCM-enabled playback/recording application 205. That is, media library 212 is not a dll and is not implemented as a standalone object. In other words, because media library 212 is linked directly into the CCM-enabled playback/recording application 205, a system hook 285 is not able to hook digital media content as it is passed from the CCM-enabled playback/recording application 205 to the media library 212.

In addition, in one embodiment, the media library 212 operates below both the kernel mode and the driver level. As such, during the transmission of the digital media from the media library 212 to the media filter driver 220 via new pathway 213, there is no unsecure kernel mode or driver level mode pathways for system hook 285 to “hook”.

For example, instead of using the commonly used pathway 207 to deliver copyright protected media content, such as raw wave data, to an OS media subsystem 215 for rendering, the CCM-enabled playback/recording application 205 will utilize custom media library 212 to generate a new pathway 213 and deliver the raw wave data directly to the media filter driver 220. In other words, in one embodiment, the utilization of media library 212 will provide more general control over the media stream while increasing compatibility and reliability of the overall solution. For example, media library 212 would involve the configuration of new pathway 213 within the computer system 200 to securely deliver the media to a media filter driver 220 at the kernel level.

At the same time, the CCM-enabled playback/recording application 205 will inform CCM 100, via communication pathway 214, that copyright protected raw data will be received at media filter driver 220 and that protection is to be enabled at the kernel mode. As described herein, the CCM 100 is able to protect the copyright protected media by, in one embodiment, instructing the media device driver 225, via switch 221, to suppress waveform input operations. Moreover, in some cases, the CCM 100 may also instruct media device 230, via switch 231, to suppress waveform output operations such as digital output 235.

Thus, in one embodiment, controlled media directed for rendering at the OS media subsystem 215 will first pass securely from the secure CCM-enabled playback/recording application 205 to the media filter driver 220 and then remain secure during rendering by CCM 100.

In one embodiment, requests for non-secure media traffic would also be controlled by media library 212 utilizing the new pathway 213. However, in another embodiment, requests for non-secure media traffic may pass directly from the CCM-enabled playback/recording application 205 to the OS media subsystem 215 via the commonly used pathway 207. When passing the media directly from the CCM-enabled playback/recording application 205 to the OS media subsystem 215 via the commonly used pathway 207, the media would be susceptible to system hook 285 and recording application 290. Of course, since the media utilizing the commonly used pathway 207 is uncontrolled, utilizing the system hook 285 in an attempt to obtain a subversive copy of the media would be immaterial since the media may be legally copied.

In another embodiment, for media devices 230 that support “standard” streaming at the kernel level, the OS media subsystem 215 may issue a request to the media device 230 for each block of data to be read for a capture operation. In one embodiment, if the media is controlled, the CCM 100 can intercept each request, such as at switch 221 and control the content in the data buffer that is returned to the OS media subsystem 215. As stated herein, the CCM 100 control can include (but is not necessarily limited to) the muting of the waveform data, and the introduction of distortion into the media stream.

For media devices 230 that either support “looped” streaming or the WaveRT port type, the OS media subsystem 215 may issue one or more requests at the start of the capture operation to either provide the location of the application-specific media buffer to be used for the operation or obtain the address of the driver-provided capture buffer. The OS media subsystem 215 will then pass data directly to the recording application 290 using these buffers, and thus the CCM 100 will be unable to monitor the data stream during the capture operation. In one embodiment, to prevent unauthorized recording for media devices 230 supporting these techniques, the CCM 100 will instruct the media device 230 to stop the capture operation at switch 221 and/or switch 231. If the recording application 290 or OS media subsystem 215 attempts to subsequently restart the capture, the CCM 100 will detect the restart request and prevent the request from being serviced by the media device 230.

For the purpose of clarification, “standard” streaming is the technique where multiple data buffers are used to stream audio data, with the kernel acting upon one buffer at a time. “Looped” streaming uses a single shared buffer, with the client and the kernel acting upon different regions within the buffer. “WaveRT” uses a mechanism similar to looped streaming, except that the buffer is allocated and managed by the audio device rather than the kernel.

As described herein, the CCM 100 will monitor the system 200 for unauthorized capture operations. Upon detection of such operations, CCM 100 can respond by continuing to allow playback of secure media data while controlling media capture, or to control the playback of the media data. This control can include (but is not necessarily limited to) the muting of waveform input or output, and the introduction of distortion into the media stream.

Thus, by utilizing the technology described herein, that is, the secure delivery of copyright protected media via the media library 212 using the user mode new pathway 213 and the CCM 100, unsecure OS media subsystem 215 is bypassed and the digital media content is passed to lower level media components, such as media filter driver 220, protected by the CCM 100. Then, when the copyright protected digital media content is then passed from the media filter driver 220 to the OS media subsystem 215 for rendering, it is already protected by the CCM 100 and the previously utilized direct sound pirate system hook 285 will no longer be able to access the media.

In other words, the copyright protected media remains in a secure environment the entire time it is on the computer system 200. Because the computer system 200 provides a secure environment for the copyright protected media, in one embodiment no additional measures, such as encryption, or the like on any or all of the copyright protected media are necessary for ensuring copyright compliance.

### Royalty Collection

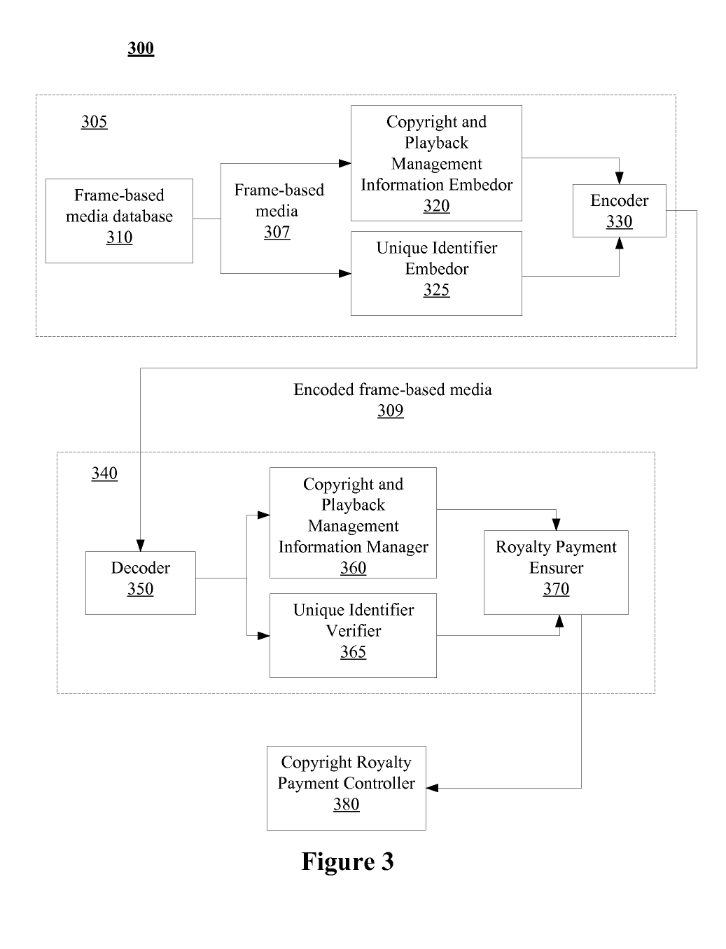

A media provider, such as a media web broadcaster, that provides a large database of media, such as but not limited to sound recordings, may transmit large volumes of copyrighted media and may be required to pay large amounts of royalty fees. An embodiment in accordance with the present invention provides a system 300 for enhancing copyright revenue generation, as illustrated in FIG. 3. System 300 includes a system 305, a device 340 and a copyright royalty payment controller 380. The system 305 includes a frame-based media database 310, a copyright and playback management information embedor 320, a unique identifier embedor 325 and an encoder 330.

The system 305 facilitates in the enhancing of copyright revenue generation by facilitating in the ensuring of appropriate payment of entitled copyright royalties. In one embodiment, the system 305 is a web broadcaster that broadcasts multimedia via the Internet. It should be appreciated that the multimedia is any frame-based media 307 which is stored in a frame-based media database 310. In one embodiment, the frame-based media 307 are MPEG-1 Audio Layer 3 (MP3) files.

In one embodiment, the system 305 facilitates the ensuring of appropriate payment of entitled copyright royalties of copyright works by introducing technological measures to the a copyright protected frame-based media 307 by way of copyright and playback management information embedor 320. In another embodiment, the system 305 facilitates the ensuring of appropriate payment of entitled copyright royalties of copyright works by introducing technological measures to the copyright protected frame-based media 307 by way of unique identifier embedor 325.

It should be appreciated that the copyright and playback management information can be but is not limited to a SCMS. SCMS is a scheme to protect copyrights of digital productions by preventing data from being repeatedly copied. SCMS is built into a media appliance which has a function to create a copy of digital data, such as an MP3 file. The media appliance with the SCMS built into it can prevent a first-generation copy recorded by the user from being copied again. In other words, the SCMS prevents a second or higher generation copy from being created.

Copyright and playback management information embedor 320 embeds copyright and playback management information within frame-based media 307. It should be appreciated that the copyright and playback management information is any information related to the management and/or the enforcement of copyright protection associated with a copyright protected work. In various embodiments, the copyright and playback management information can be but is not limited to the number of copies allowed of the frame-based media, the number of copies allowed of the frame-based media, version number of the frame-based media or no copies allowed, rules for subsequent copies and the like, as well as the number of plays allowed of the frame-based media and the types of devices that are allowed to play the media.

In one embodiment, the copyright management information indicates which machine, product and/or company the copyright protected work came from and/or is allowed to be played back on. It should also be appreciated that the copyright management information may be forensics related information, such as but not limited to tracking information. Further, in one embodiment, the copyright management information is an expiration date(s) associated with the copyright protected work.

It should be appreciated that the copyright and playback management information embedor 320 embeds copyright and playback management information within at least one data field of the frame-based media 307. In one embodiment, the data field is an application-private bit of a MP3 file. Typically, MP3 files are segmented into thousands of frames. For example, a three to five minute song can have approximately 8,000 to 12,000 frames. Each frame contains a fraction of a second's worth of audio data. At the beginning of every data frame is a header frame which stores 32 bits of meta-data related to the coming data frame. The MP3 header begins with a sync block that consists of 11 bits. The sync block allows players to search for and lock onto the first available occurrence of a valid frame. Following the sync block are a plurality of other header blocks that facilitate in the proper decoding and subsequent playing of the MP3 file. One of the other header blocks is the application-private bit, which allows for application-specific triggers. For example, if there are 8,000 frames in an MP3 file, there is a private bit corresponding to each frame for a total of 8,000 private bits.

In one embodiment, the copyright and playback management information is a multiple bit data structure using the application-private bits in the MP3 frame headers across consecutive audio frames. For example, if the copyright and playback management information contains 32 bits, then each bit is stored in 32 consecutive application-private bits in corresponding 32 consecutive frames. In particular, the first bit of the copyright and playback management information is stored in the application-private bit of the header for the first audio frame. The second bit of the copyright and playback management information is stored in the application-private bit of the second audio frame and so on until all the data in the copyright and playback management information is stored in consecutive frames.

Further, the sequence of bits associated with the copyright and playback management information data block is continuously repeated throughout the entire audio file. Once the entire data block has been encoded, the first bit of the copyright and playback management information data block is stored in the application-private bit of the header for the next frame within the MP3 file. Accordingly, the playback application is able to detect the copyright and playback management information for the audio file irrespective of the starting position within the file from which the playback was initiated. For example, if the MP3 file has 8,000 frames and a corresponding 8,000 application private bits, then a copyright and playback management information data block of 32 bits is initially stored in the first 32 consecutive application-private bits and repeatedly stored in consecutive application-private bits, for a total of 250 consecutive and repeated instances of the copyright and playback management information data block stored in the entire MP3 file.

In one embodiment, the copyright and playback management information (CMI) is a 32-bit data structure having the following format. It should be appreciated that the 32-bit data structure is a SCMS data structure used to encode playback rights information in addition to copy control information. For example, a copyright holder may choose to allow a particular work to be played freely a certain number of times before requiring a license key or other access mechanism.

Elements of the 32-bit data structure are shown in Table 1:

| Offset | Description |
|---|---|
| 0 | First byte of CMI, set to fixed value to facilitate detection |
| | by a playback or secure copy/playback application |
| 8 | Second byte of CMI, set to fixed value to facilitate detection |
| | by a playback or secure copy application |
| 16 | Version number of CMI (three binary bits) |
| 19 | Flag indicating copying not allowed for media file |
| 20 | If bit at offset 19 is not set, number of copies allowed for |
| | file (up to a maximum of 15). A value binary 0000 indicates |
| | that the file may be freely copied. |
| 24 | Number of plays allowed for file (up to a maximum of 255). |
| | If this field is set to binary 00000000, the file can be freely |
| | played. |

Additional security is available by using an encryption mechanism. Specifically, an encoder generates one or more sequences of data bytes to be used as keys for the encoding of the media data for the file. The key sequences can be derived from a cryptographically secure digest taken across all or part of the data for the file. Thus, the key sequences are most likely different for each media file.

The key sequences that are used for the encryption for all or part of the SCMS data block are unique to each copyright protected work. The key sequences can be generated using data from the copyright protected work. Thus the SCMS data block can be used to help ensure the integrity and authenticity of the copyright protected work.

It should be appreciated that to allow playback devices to more easily detect the presence of copyright and playback management information, the two marker bytes for each copyright and playback management information data block can be left unencoded.

In one embodiment, system 305 facilitates in the ensuring of appropriate payment of entitled copyright royalties of the copyright protected frame-based media 307 by adding technological measures to the frame-based media via unique identifier embedor 325. Unique identifier embedor 325 embeds at least one unique identifier into a frame-based media file. In one embodiment, the at least one unique identifier is invariant and is embedded into metadata, such as but not limited to an ID3V2 tag. Further, in one embodiment, at least one unique identifier may be a valid copyright registration number from the United States Copyright Office associated with copyright protected frame-based media 307. In another embodiment, at least two copyright registration numbers are embedded into ID3V2 tags of an MP3 file.

System 305 encodes the frame-based media subsequent to the copyright and playback management information embedor 320 embedding copyright and playback management information into the frame-based media 307 and/or the unique identifier embedor 325 embedding at least one unique identifier into the frame-based media 307.

Transcoding can be performed on a frame-based media that results in frameless media. For example, an MP3 file can be transcoded into another format (e.g., wav, AC3), such that it loses its frames, header, footer and as a result all that is left are the payloads. In a frameless media file, the copyright and playback information can be encoded by selecting a certain frequency not usually perceived by the listener and then changing its value to reflect the copyright and playback information data. For example, if a low frequency is selected and sampled, such that there is a guaranteed match on a significant pattern, the copyright and playback information can be further read for copyright and playback rules.

Media device 340 includes a decoder 350 that decodes the encoded frame-based media 309, copyright and playback management information manager 360, unique identifier verifier 365 and royalty payment ensurer 370. Copyright and playback management information manager 360 manages the frame-based media 307 according to the copyright and playback information that is embedded into the frame-based media.

Unique identifier verifier 365 verifies that the at least one unique identifier embedded in the decoded frame-based media is the same unique at least one unique identifier that was embedded into the frame-based media 307. In one embodiment, unique identifier verifier 365 verifies that the two copyright registration numbers associated with the MP3 file embedded in the ID3V2 tags of an MP3 file are the same two copyright registration numbers associated with the MP3 file embedded in the ID3V2 tags subsequent decoding of the MP3 file in the device 340. It should be appreciated that if the unique identifier verifier 365 determines that the at least one unique identifier decoded at device 340 is the same as the at least one unique identifier that was embedded into the frame-based media 307, then it helps determine that the decoded frame-based media 307 has not been tampered with and is not a counterfeit. It should also be appreciated that the ID3V2 tags are metadata in the MP3 frame headers, as described above.

In one embodiment, the royalty payment ensurer 370 facilitates in ensuring appropriate payment of entitled copyright royalties of the copyright protected frame-based work 307 based at least in part on the embedded copyright and playback management information. In another embodiment, the royalty payment ensurer 370 facilitates in ensuring appropriate payment of entitled copyright royalties of the copyright protected frame-based work 307 based at least in part on the embedded at least one unique identifier. Typically, the copyright owner of a copyright protected work is entitled to copyright royalties upon the transmission of a frame-based media 307. Based at least in part upon the output of the copyright management information manager 360 and the unique identifier verifier 366, the copyright owner of the frame-based media is ensured appropriate payment of entitled royalties.

The copyright royalty payment controller 380 receives information from the device 340 and pays the copyright owner of the copyright protected work for the use of the copyright protected work accordingly. It should be appreciated that the copyright royalty payment controller 380 can be but is not limited to a performing rights organization (e.g., The American Society of Composers, Authors and Publishers, Broadcast Music, Inc., SESAC, Inc. and SoundExchange) and/or mechanical rights agency (e.g., Harry Fox Agency and Canadian Mechanical Rights Reproduction Agency).

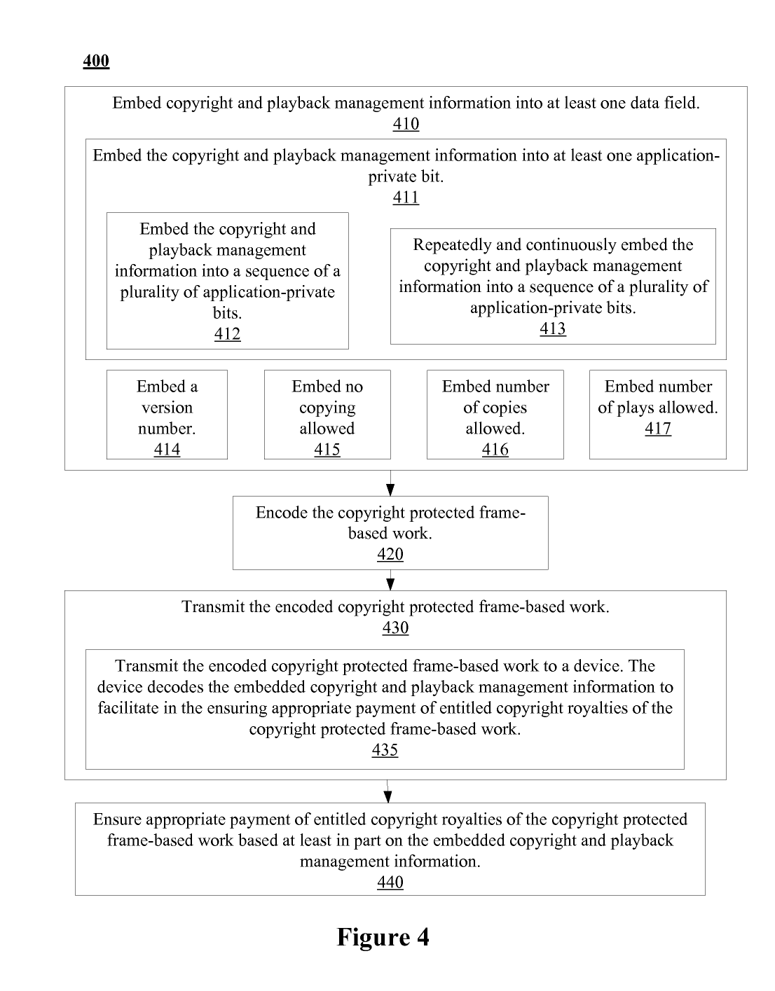

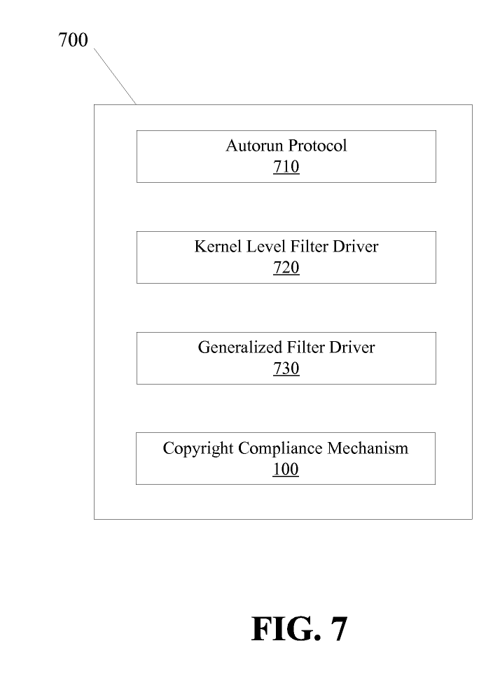

FIG. 4 is a flowchart illustrating a process 400 for enhancing copyright revenue generation. In one embodiment, process 400 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In one embodiment, process 400 is performed at least by system 700 of FIG. 7.

At block 410 of FIG. 4, copyright and playback management information is embedded into at least one data field of the copyright protected frame-based work. The copyright and playback management information corresponds to access to the copyright protected frame-based work. In one embodiment, at block 411, the copyright and playback management information is embedded into at least one application-private bit of at least one corresponding frame of a MP3 file. In another embodiment, at block 412, the copyright and playback management information is embedded into a sequence of a plurality of application-private bits. In another embodiment, at block 413, the copyright and playback management information is repeatedly and continuously embedded into a sequence of a plurality of application-private bits.

In another embodiment, at least two unique identifiers are embedded into at least two data fields of the copyright protected frame-based work. The embedding of the at least two unique identifiers corresponding to access to the copyright protected frame-based work. For example, the at least two unique identifiers may be embedded into an ID3V2 tag of at least one corresponding frame of a MP3 file. In another embodiment, a copyright registration number for an underlining sound recording and/or an underlining composition corresponding to the copyright protected frame-based work is embedded into the frame-based work.

In yet another embodiment, an audio frequency is selected that is not usually perceived by a listener of the copyright protected work. The copyright protected work is a frame-based work that is transcoded to a frameless work. For example, the copyright and playback management information is encoded within the selected audio frequency not usually perceived by a listener of the copyright protected work.

At block 414, the copyright and playback management information is a version number of the work. At block 415, the copyright and playback management information is no copying allowed of the work. At block 416, the copyright and playback management information is a number of copies allowed for the work. At block 417, the copyright and playback management information is a number of plays allowed for the work.

At block 420, the copyright protected frame-based work is encoded. At block 430, the encoded copyright protected frame-based work is transmitted. In one embodiment, at block 435, the encoded copyright protected frame-based work is transmitted to a device. The device decodes the embedded copyright and playback management information to facilitate in the ensuring appropriate payment of entitled copyright royalties of the copyright protected frame-based work. At block 440, appropriate payment of entitled copyright royalties of the copyright protected frame-based work is ensured based at least in part on the embedded copyright and playback management information.

### Secure Copy/Playback

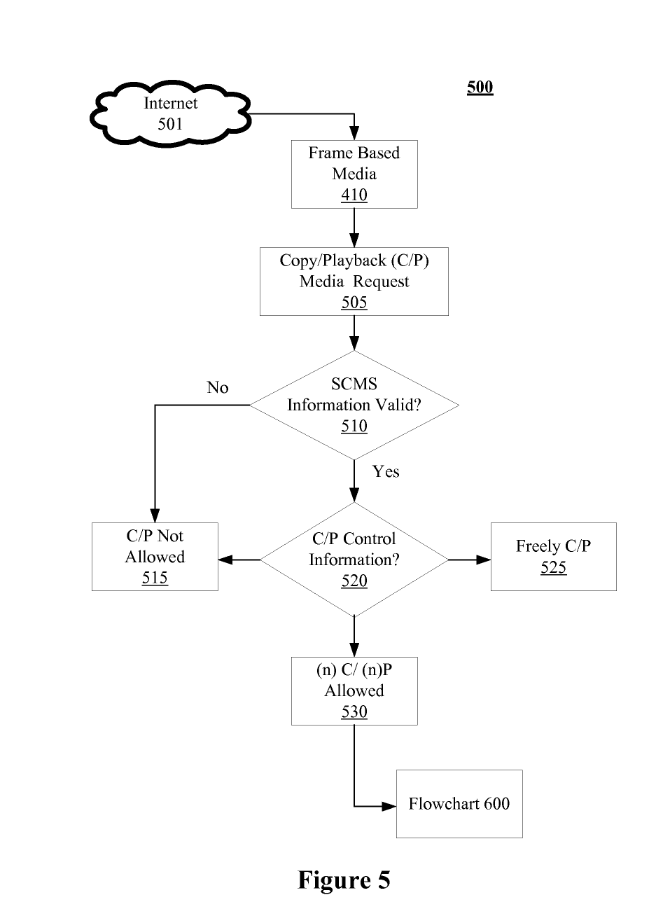

With reference now to FIG. 5, a flow chart 500 of a method for determining if secure media copying and/or playback (C/P) of digital media content in a usage protected frame-based work is allowed is shown in accordance with an embodiment of the present invention. In one embodiment, the method described herein provides a number of rules that a secure copy/playback application may follow in order to be compliant with SCMS and CMI. While the following rules are provided as one exemplary embodiment for secure copy and/or playback limitation, it should be understood that in other embodiments, additional rules may be added or presently provided rules may be ignored. Moreover, in the present discussion, the term copy is utilized, however in alternate embodiments, copying may be replaced by terms such as duplication, sharing, and the like.

With reference now to 501 of FIG. 5, one embodiment utilized the Internet to deliver multimedia broadcasts. It should be appreciated that the multimedia may be any frame-based media 107 stored in a frame-based media database 110. In one embodiment, the frame-based media 107 are MPEG-1 Audio Layer 3 (MP3) files. The methods and systems described with respect to FIGS. 1-4 may then be performed on or utilized with respect to the multimedia.

Referring now to 505 of FIG. 5, a copy and/or Playback (C/P) media request is generated.

With reference now to 510 of FIG. 5, the frame based media 410 is checked for valid SCMS information. In one embodiment, the following terms are utilized to clarify and differentiate between the numerous possible configurations of frame-based media 410. For example, the original frame-based media 410 will either have valid SCMS data or it will have invalid or missing SCMS data. Original frame-based media 410 having invalid or missing SCMS data is also referred to herein as a destination file.

As shown at 515, a destination file of frame based media 410 is a C/P not allowed version. For example, the SCMS frame-based work will not permit a destination file to be copied if it can be definitively determined that the source file has no SCMS information. In one embodiment, although the copying and playback control utilize the same structure, it does not mean that a no-copy file is an unplayable file or that an unplayable file is a no-copy file. In other words, it is quite possible that a user will have a media file that does not contain SCMS information. As such, although a copy may not be allowed, it does not mean that the file cannot be freely played.

For example, in one embodiment, the media file may be from a source that did not include SCMS information. As such, the secure copy/playback application would ensure no-copies are made, thereby supporting owner copyrights. However, the secure copy/playback application may not necessarily stop the file from being played.

In another embodiment, if the media file does not contain SCMS information, the secure copy/playback application may not allow copying or playback of the media.

With reference again to 515 of FIG. 5, if the source file has detectable SCMS information, but the information is either corrupt or internally inconsistent, then the secure copy/playback application should not copy the file. Again, in one embodiment, the playback of the file may also be not allowed.

The following examples illustrate a few of the plurality of possible cases where tampering of the SCMS information in a frame-based MP3 file can be suspected.

If the MPEG audio tag or ID3v2 tag for the media file has been modified, the encoded portion of the SCMS data block will decode to invalid information.

If the application-private bits for some of the MP3 frame headers have been modified, but not all of the frame headers, then one or more valid SCMS data blocks may be detected within the file.

In contrast, in one embodiment, the file may be considered to have valid SCMS information based on heuristics including, but not limited to:

An SCMS marker sequence is found at least once within the media file.

The copyright, original, and protect bits are set in all of the media frames for the file.

Fields within the SCMS data block that are marked as reserved are set to zero, and version information is set to a recognized value.

In another embodiment, the file will have valid SCMS information if all of the following conditions are met:

For every media frame in the file, the frame header has the copyright, original, and protect bits set.

SCMS data blocks are found throughout the entire media file, and these data blocks have valid formats. Specifically, each SCMS data block has the correct two-byte marker, the version field corresponds to a recognized version of the SCMS specification, and the reserved field is set to a value of zero.

In one embodiment, it is possible for an encoding application to set the application-private bits in the frames for an MP3 file to arbitrary values. It is also possible that an encoding application will use the application-private bit for its own purposes. In general, the utilization of the application-private bit will not necessarily invalidate the SCMS information.

With reference now to 520 of FIG. 5, in one embodiment, original frame-based media 410 having valid SCMS data will include C/P control information such as the information 410-417 of FIG. 4. For example, information addressing the number of copies (n) allowed to be made or playbacks allowed to be played. The number of copies (n) or playbacks will normally be defined by the copyright owner or distributor. In general, the number of copies (n) and or the number of playbacks will fall into one of three categories: n=unlimited, n=a certain number and n=0. In general, the number of playbacks does not need to correlate with the number of copies. Although, in one embodiment, as described in further detail herein, the number of playbacks may be established for each copy during the copying of the file.

At 525 of FIG. 5, a frame-based media 410 having valid SCMS data that has a value n=unlimited is referred to herein as an unlimited file. In one embodiment, an unlimited file may be freely C/P. Moreover, an unlimited file may be C/P by, or outside of, the secure copy/playback application defined in flowchart 600.

In contrast, at 515 of FIG. 5, a frame-based media 410 having valid SCMS data that has a value n=0 would be similar to C/P not allowed 415 of FIG. 4, also referred to herein as a destination file. In other words, if the copy control information specifies that copying is not permitted for the file, then the secure copy/playback application should not copy the file. Additionally, if the original bit in any of the MP3 frame headers for the source file is not set, then the secure copy/playback application should not copy the file, irrespective of the state of the original bits in the headers for the other frames in the file. Moreover, in one embodiment, if the source file is copy protected, or otherwise cannot be modified, then the secure copy/playback application should not copy the file.

However, although in one embodiment the copying and playback control utilize the same structure, it does not mean that a no-copy file is an unplayable file or that an unplayable file is a no-copy file. In other words, although the copy and/or playback utilize the same processes, in one embodiment, they are independent. Thus, it is quite possible that a user will have a no-copy media file that may be freely played.

With reference to 530 of FIG. 5, in one embodiment a frame-based media 410 having valid SCMS data that provides for a limited number (n) of copies and/or a limited number of playbacks allowed such as shown at 416 of FIG. 4, is referred to herein as a source file. For clarity, the following discussion is directed toward a source file that is allowed to be copied a total of (n) times. However, in another embodiment, if it is the playbacks that are limited to a certain number (n), the number of playbacks may be similarly controlled. In yet a further embodiment, both the number of copies and the number of playbacks may be simultaneously controlled for a given media file.

With respect now to flowchart 600, a method for secure media copying of digital media content utilizing a usage protected frame-based work is shown in accordance with an embodiment of the present invention. For example, once the copy control information at 520 and 530 of FIG. 5 specifies that the creation of one or more copies is allowed, secure copy/playback application 612 will make a destination file 625 of source file 610.

In one embodiment, secure copy/playback application 612 generates a target file 615 before initiating the copy process. In general, target file 615 is a working copy of source file 610. In one embodiment, the target file is an exact duplicate of the source file including the (n) value. The secure copy/playback application will then utilize target file 615 to generate the destination file 625 and the source file 630. In so doing, if any copying errors damage the file being copied, it is target file 615 that is damaged and not source file 610. In another embodiment, secure copy/playback application 612 may not utilize a target file 615 and may perform the copying process directly from source file 610.

In one embodiment, when target file 615 is copied by the secure copy/playback application 612, the result will include a destination file 625 and a source file 630 having (n−1) available copies remaining. In another embodiment, if secure copy/playback application 612 performs the copying process directly from source file 610, the result may include a destination file 625 and a source file 630 having (n−1) available copies remaining. However, in yet another embodiment, if secure copy/playback application 612 performs the copying process directly from source file 610, the result may include a destination file 625 and a change only to the copy allowance from (n) to (n−1) within source file 610.

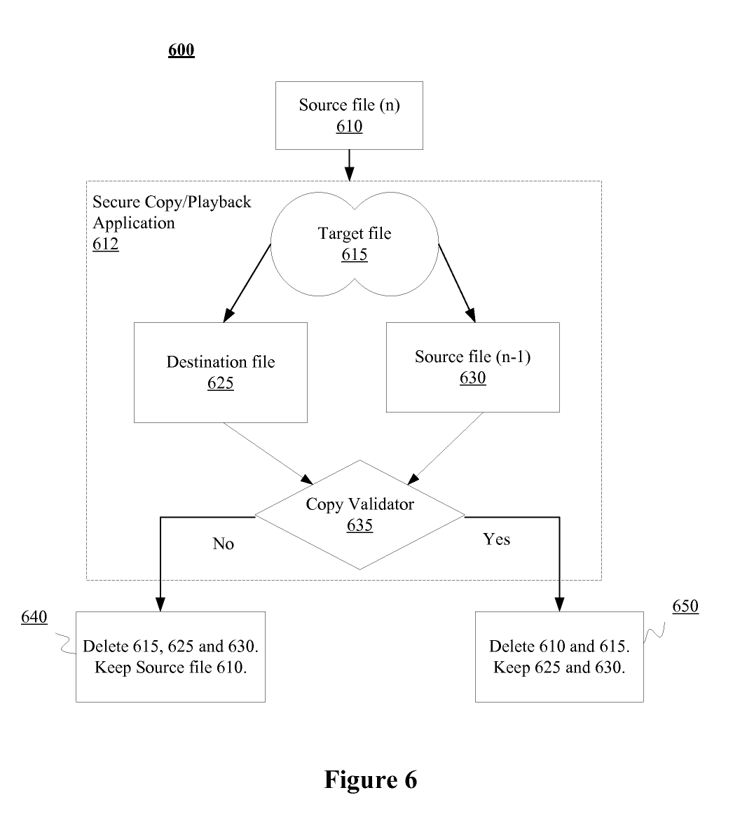

With reference still to FIG. 6, in one embodiment the destination file 625 has valid SCMS information specifying that copies are not permitted. In addition, in one embodiment, the original media bit in the MP3 frame headers for the destination file 625 should not be set, but the copyright and protect bits should be set.

In one embodiment, when source file 630 is created, the copy control information for source file 630 is modified to reflect that destination file 625 has also been made. For example, if the copy control information for source file 610 indicated that three copies were permitted (n=3) before the copy operation was performed, then source file 630 would show two allowed copies remaining (n=2). When the last allowed copy is made, the copy control information should be set to indicate that copying is not permitted for source file 630 (n=0). In other words, when the number of copies of the source file reaches (n=0) the two final copies will include a destination file 625 and a source file 630 with (n=0), the difference between the two being that the destination file will not have the original media bits set in the MP3 frame headers. At that time, the frame-based media 410 would no longer be able to be copied.

In one embodiment, validator 635 of FIG. 6 validates destination file 625 and source file 630. For example, as shown at 640, if an error occurs during the copy operation and the copies cannot be validated, the source file 610 is restored, and the target file 615, destination file 625 and source file 630, if created, are deleted. Thus, by utilizing the target file 615 even if the error condition that caused the copy operation to fail deleteriously affects target file 615, the integrity of source file 610 is maintained. In other words, by utilizing the target file 615 the secure copy/playback application is able to without compromising the copy control for the source file 610.

However, with reference now to 650 of FIG. 6, if destination file 625 and source file 630 are validated, then source file 610 and target file 615 are deleted and destination file 625 and source file 630 adjusted to now allowable copies (n−1) are kept. In one embodiment, both flowcharts 500 and 600 may be repeated until no further copying is allowed. In one embodiment, during the generation of the last available destination file, the result of the copying will include two destination files.

Although the example herein utilized 3 copies allowed per source file 610 or 10 playbacks per file, these numbers are provided merely for purposes of clarity within the examples provided. Thus, it is possible that the number of copies allowed or number of playbacks per file may be fixed at a different number and may also vary by content or media type. For example, in one embodiment a media copyright owner may choose another value for the number of copies allowed and/or number of playbacks per file.

Furthermore, in one embodiment, if there is a difference between the rule for the number of copies or plays allowed with respect to the SCMS and the number of copies or plays defined by the copyright owner, the number of copies allowed will default to the lesser of the number of copies. For example, the number of copies allowed may be set to default to the SCMS number of copies allowed as long as it is not larger than the copyright owner's suggested number of copies.

In another embodiment, if the copyright owner and the SCMS have a differing number of copies allowed rules (e.g., SCMS (4) copies; copyright owner (6) copies), a hierarchical rule may be utilized such that preference is provided to one over the other regardless. For example, the number of copies allowed would become the copyright owner's suggested number of copies (6).

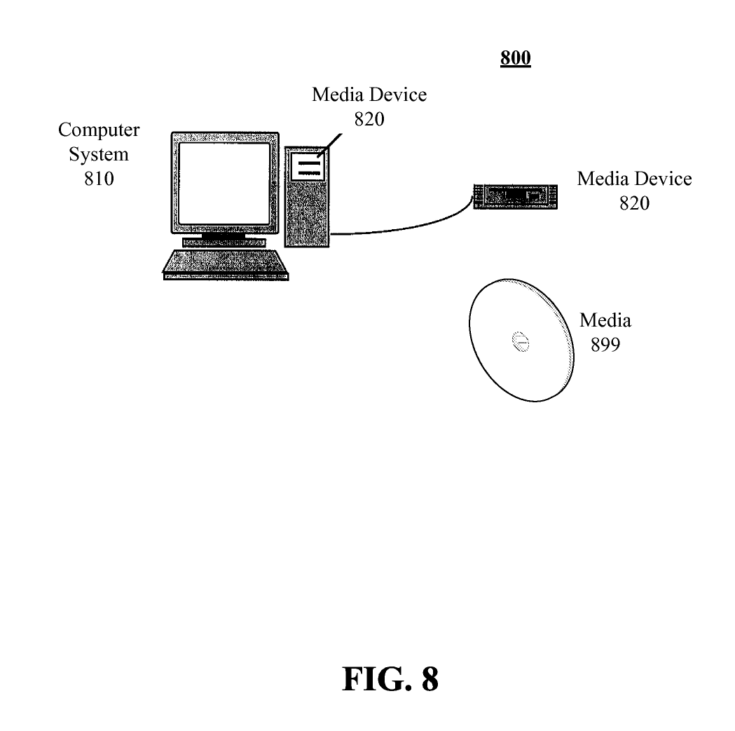

FIG. 7 is a block diagram of a copyright compliance mechanism/media storage device (CCM/MSD) 700, a version of CCM 100 adapted to be disposed on a media storage device, (e.g., 899 of FIG. 8) in accordance with an embodiment of the present invention. It is noted that CCM 100 in CCM/MSD 700 is analogous to CCM 100 as described in FIG. 1. Further, CCM/MSD 700 can be readily updated in accordance with a global delivery system.

In one embodiment, CCM/MSD 700 is adapted to provide stand-alone compliance with copyright restrictions and/or licensing agreements applicable to media files that may be disposed on a media storage device, (e.g., 899). In another embodiment, CCM/MSD 700 is adapted to be installed on a computer system, (e.g., 810) to provide compliance with copyright restrictions and/or licensing agreements applicable to media files.

Referring to FIG. 7, CCM/MSD 700 includes an autorun protocol component 710 for invoking automatic installation of CCM 100. To deter users from attempts at defeating various features inherent to CCM 100, (e.g., the autorun feature), CCM 100's monitoring program, agent program 104, verifies that those features that are to be operational are operational, and if not, CCM 100 prohibits the user from experiencing the contents of the media storage device.

If a user somehow defeats the autorun feature, and the user attempts to utilize an application to capture an image of the content, the application will make an image of the content on the media storage device, which also images the copyright protection contained thereon. As such when the image is played, CCM 100 recognizes the copy protection is present, and CCM 100 will only allow the user to experience the content when authorized, once CCM 100 is installed.

By virtue of the protections as described above provided by CCM 100, users will be able to experience the content of the media storage device in the content's original high quality format, thereby obviating the need to compress the media file used on client system 810. Advantageously, the user will no longer need to suffer through poor quality output as a result of severely compressed media files.

It is noted that when adapted to be implemented in conjunction with a secure file format, meaning that the format of the file is, without proper authorization, non-morphogenic, embodiments of the present invention also provide effective compliance with copyright restrictions and/or licensing agreements with secure files formats. CCM 100 can control the types of file formats into which the media file can be transformed, (e.g., .wav, .mp3, etc.).

In one embodiment, the autorun feature associated with a media storage device drive, (e.g., 820 of FIG. 8) of client system 810 is activated and operational. Alternatively, a notice of required autorun activation within client system 810 may be displayed on the media storage device and/or the case in which the media storage device is stored.

In another embodiment, if CCM 100 is present or if the user is coupled to a server, then messages containing instructions on how to activate the autorun feature of client system 810 may be presented to the user.

In one embodiment autorun protocol component 710 can detect media storage device drives resident on a computer system, (e.g., 810).

The following C++ source code is an exemplary implementation of a portion of autorun protocol component 710 for detecting media storage device drives residing and operable on client computer system 810, according to one embodiment of the present invention.

```
  if ( (dwRetVal = GetLogicalDrives( ))
  != (DWORD) 0)
{
  /* initialize variables */
  dwMask = (DWORD) 1;
  /* initialize path to root of current drive */
  _tcscpy(szDrive, _T(“A:\\”));
  for (nIndex = 0, dwMask = (DWORD) 1;
    dwMask != (DWORD) 0;
    nIndex++, dwMask <<= 1)
  {
    if ((dwRetVal & dwMask) != 0)
    {
      /* construct path to root of drive */
      szDrive[0] = (TCHAR) ‘A’ + nIndex;
      if (GetDriveType(szDrive) == DRIVE_CDROM)
      {
        MessageBox((HWND) 0,
            _T(“CD-ROM drive found.”),
            szDrive,
            MB_OK);
      }
      else
      {
        /* clear bit at current position */
        dwRetVal &= (~dwMask);
      }
    }
  }
}
```

In another embodiment, autorun protocol component 710 can detect whether a media storage device containing media files has been inserted into a media storage device drive coupled with client computer system 810, (e.g., drive 820 of FIG. 8). In another embodiment, CCM 100 can include instructions for monitoring media storage device drive 820, and upon detection of drive activation, CCM 100 determines what type of media storage device has been inserted therein. Subsequently, CCM 100 can detect various triggers on the media storage device to invoke its protection, (e.g., a hidden file on newer media storage devices and/or the copyright indicator bit on legacy media storage devices), obviating the need for autorun. Upon detection, CCM 100 can invoke the appropriate protection for the associated media file.

The following C++ source code is an exemplary implementation of a portion of autorun protocol component 710 for detecting a media storage device inserted in a media storage device drive residing and operable on client computer system 810, according to one embodiment of the present invention.

```
  /* set error mode for operation */
uiErrMode = SetErrorMode(SEM_FAILCRITICALERRORS);
/* initialize path to root of current drive */
_tcscpy(szDrive, _T(“A:\\”));
for (nIndex = 0, dwMask = (DWORD) 1;
  dwMask != (DWORD) 0;
  nIndex++, dwMask <<= 1)
{
  if ((dwCDROMMask & dwMask) != 0)
  {
    /* construct path to root of drive */
    szDrive[0] = (TCHAR) ‘A’ + nIndex;
    if ( GetDiskFreeSpace(szDrive,
                  &dwSectors,
                  &dwBytes,
                  &dwClustersFree,
                  &dwClusters)
      != 0)
    {
      /* add bit for drive to mask */
      dwRetVal |= dwMask;
    }
  }
}
/* restore original error mode */
SetErrorMode(uiErrMode);
```

Additionally, autorun protocol component 710 can also detect changes in media, (e.g., insertion of a different media storage device 899). Further, other media changes can be detected subsequent to adaptation of the source code including, but not limited to, detecting a previously accessed media file and/or detecting a previously inserted media storage device.

The following C++ source code is an exemplary implementation of a portion of autorun protocol component 710 for detecting a change in media, according to one embodiment of the present invention.

```
  /* initialize path to root of current drive */
_tcscpy(szDrive, _T(“A:\\”));
for (nIndex = 0, dwMask = (DWORD) 1;
    dwMask != (DWORD) 0;
    nIndex++, dwMask <<= 1)
{
    /* check for presence of CD-ROM media in drive */
    if ((dwCurrMask & dwMask) != 0)
    {
      /* check if media previously in drive */
      if ((dwPrevMask & dwMask) == 0)
      {
        /* construct path to root of drive */
        szDrive[0] = (TCHAR) ‘A’ + nIndex;
        /* check for presence of marker on drive */
        if (IsMPBMarkerPresent(szDrive) != 0)
        {
          /* process autorun information present on drive */
          nRetVal = ProcessAutorun(szDrive);
        }
      }
    }
}
```

Still referring to FIG. 7, CCM/MSD 700 also includes a kernel level filter driver 720 for controlling a data input path of an operating system coupled with and operable on client computer system 810.

CCM/MSD 700 also includes a generalized filter driver 730 for controlling ripping and “burning” applications, (e.g., Nero, Roxio, Exact Audio Copy, and others), thereby preventing such activities.

The following C++ source code is an exemplary implementation of a portion of generalized filter driver 730 for controlling ripping and burning applications that may be residing on and operable within client computer system 810, in accordance with one embodiment of the present invention.

| | | |
|---|---|---|
| bool | bDisabled; | /* flag indicating CD reads disabled */ |

/* initialize variables */
bDisabled = false;
if (bProtected == true)
{

if (type == IRP_MJ_DEVICE_CONTROL)
{

ULONG ulIoControlCode = stack-

>Parameters.DeviceIoControl.IoControlCode;

if (ulIoControlCode == IOCTL_SCSI_PASS_THROUGH)
{

SCSI_PASS_THROUGH * pspt =

(SCSI_PASS_THROUGH *)
Irp->AssociatedIrp.SystemBuffer;

if ( (pspt != NULL)

&& (pspt->Cdb[0] == SCSIOP_READ_CD))

{

pspt->DataTransferLength = 0;
pspt->ScsiStatus = 0;
bDisabled = true;

}

}
else if (ulIoControlCode ==

IOCTL_SCSI_PASS_THROUGH_DIRECT)

{

SCSI_PASS_THROUGH_DIRECT * psptd =

(SCSI_PASS_THROUGH_DIRECT *)
Irp->AssociatedIrp.SystemBuffer;

if( (psptd != NULL)

&& (psptd->Cdb[0] == SCSIOP_READ_CD))

{

psptd->DataTransferLength = 0;
psptd->ScsiStatus = 0;
bDisabled = true;

}

}

}

}
if (bDisabled == true)
{

/* complete current request */
status = CompleteRequest(Irp, STATUS_SUCCESS, 0);

}
else
{

/* pass request down without additional processing */
status = IoAcquireRemoveLock(&pdx->RemoveLock, Irp);
if (!NT_SUCCESS(status))

return CompleteRequest(Irp, status, 0);

IoSkipCurrentIrpStackLocation(Irp);
status = IoCallDriver(pdx->LowerDeviceObject, Irp);
IoReleaseRemoveLock(&pdx->RemoveLock, Irp);
}

In one embodiment, kernel level filter driver 720, generalized filter driver 730 and CCM 100 of CCM/MSD 700 are automatically installed on client computer system 810, subsequent to insertion of media storage device 899 into a media storage device drive, (e.g., 820 of FIG. 8). Autorun protocol component 710, as described above, detects insertion of media storage device 899 into an appropriate drive, and initiates installation of the components, (e.g., CCM 100, driver 720 and driver 730). In one embodiment, drivers 720 and 730 may be temporarily installed and may be deleted upon removal of media storage device 899 from media storage device drive 820. In yet another embodiment, drivers 720 and 730 may be installed in hidden directories and/or files within client computer system 810. In another embodiment, some components of CCM 100 can remain installed on client system 810, (e.g. the monitoring program (agent program 104). In still another embodiment, other components, (e.g., the kernel level filter driver 720), can be dynamically loaded and unloaded as necessary in accordance with copyright restrictions and/or licensing agreements applicable to the media file.

Embodiments of the present invention utilize software, (e.g., CCM/MSD 700), that is placed on media storage device 899, in conjunction with controlling software CCM 100 installed on client computer system 810, and a web server and/or content server, wherein each component is communicatively coupled with the other via the Internet, thereby enabling dynamic updating of CCM 100 in the manner as described with reference to FIG. 1.

In the present embodiment, CCM/MSD 700 provides a stand alone DRM that is far more sophisticated than existing DRM solutions. This is because CCM/MSD 700 goes into the data pathway of the operating system operable on client computer system 810 and obtains control of the data pathway, (e.g., media filter driver 220 of FIG. 2), rather than exploiting inefficiencies or errors in the computer system.

### Media Change Notification

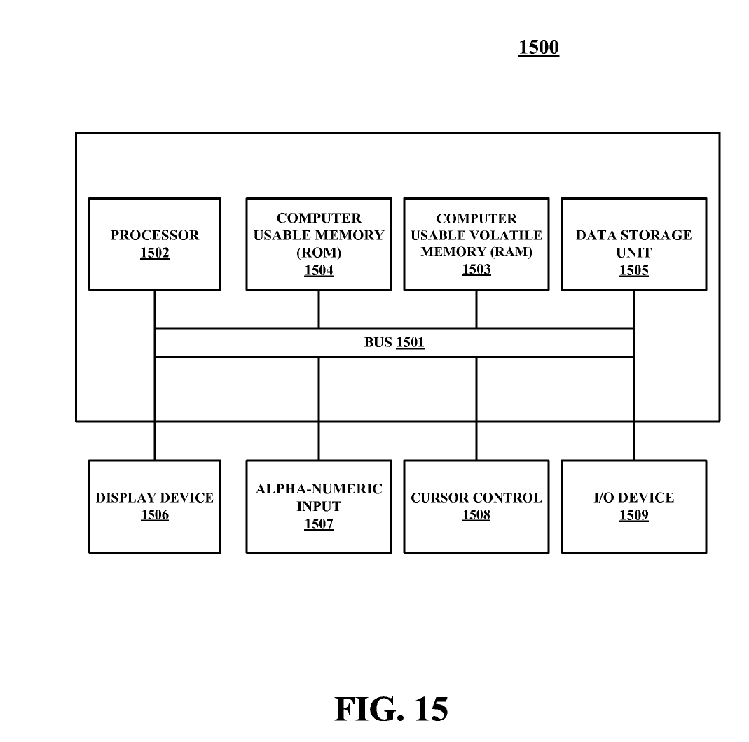

FIG. 8 is a block diagram 800 of an exemplary computing environment shown in accordance with an embodiment of the present invention. Computing environment 800 is similar to the communicative environment as shown in FIG. 15. Computing environment 800 includes computing system 810, media device 820, and media storage device 899. Computing system 810 is described in detail herein including FIG. 15. Media device 820 may be any device which can access (e.g., read, write, etc) the media stored on media storage device 899. In one embodiment, media device 820 is removably coupled with computing system 810. In another embodiment, media device 820 is internal to (or fixedly coupled with) computing system 810. As stated herein, media storage device 899 can be, but is not limited to, a CD, a DVD, or other optical or magnetic storage device. Embodiments of media on the media storage device 899 may include audio, video, multimedia, graphics, information, data, software programs, and other forms of media that may or may not contain copyrighted material and which may be disposed on a media storage device 899.

In general, the system 800 is a generic example shown for purposes of providing a generic environment in which a media change notification on a computing system may occur. In general, a media change notification occurs when new media is detected in a media device. The reasons for detecting media in a media device are important for a plurality of purposes. One purpose is that the detection of media allows the computing system to install operational components from a media storage device 899 thereby allowing access to the rest of the data stored on media storage device 899. Another purpose, as described herein, is that the detection of media initiates the autorun (or autoplay) protocol component 710 including the initial installation of CCM 300.

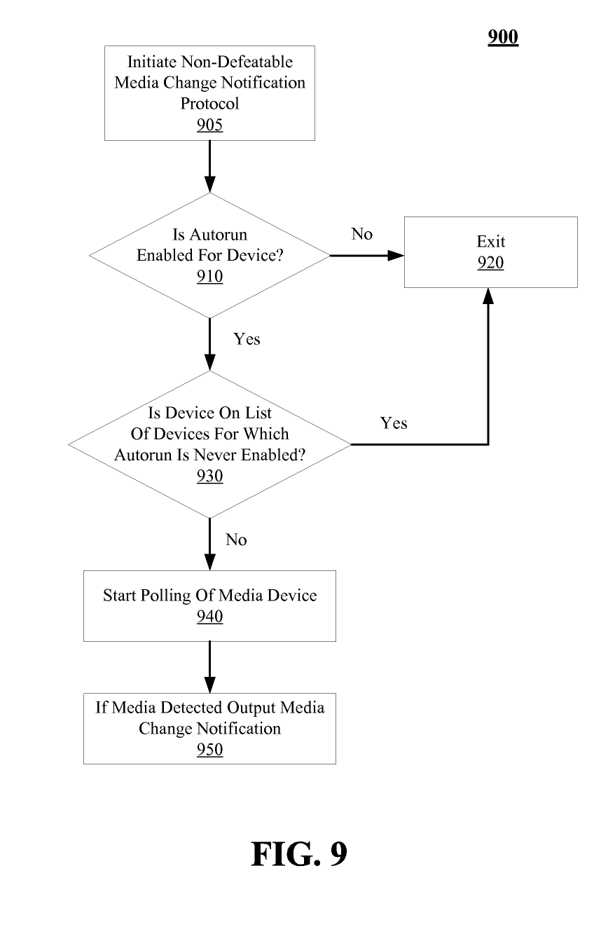

With reference now to FIG. 9, a data flow block diagram 900 of an exemplary method for providing a media change notification on a computing system is shown in accordance with an embodiment of the present invention. Data flow block diagram 900 shows the new non-defeatable media change notification (MCN) protocol 905 operating in conjunction with an autorun (or autoplay) protocol component 710.

Referring now to step 905 of FIG. 9 and to FIG. 8, in one embodiment, a non-defeatable media change notification protocol is initiated. In one embodiment, the initiation may occur at computing system 810 start-up. In addition, during start-up, a list of media devices 820 may be generated for all media devices 820 communicatively coupled with computing system 810. This list may then be accessed by the non-defeatable media change notification protocol of 905 to ensure that all media devices 820 operating on computer system 810 are known.

In one embodiment, the media change notification protocol 905 may be a modification to the existing autorun, or the media change notification protocol 905 may be a second component or plurality of components operating in parallel with an autorun component 710. In either case, the autorun component 710 may operate without any changes with respect to media devices (e.g., media device 820 of FIG. 8) while the media change notification protocol generates the MCN 950 whenever any media 899 is introduced to the media device 820.

Therefore, to the user there is no apparent change in the operation of the computing system 810 to include the autorun component 710. However, to the system, a signal (e.g., MCN 950) is being generated. Specifically, the non-defeatable MCN protocol 905 issues a MCN (e.g., a signal) when new media is detected in the media device. This signal is generated regardless of input to the computing system regarding the operation of the autorun component 710.

Referring now to step 910 of FIG. 9 and to FIG. 8, in one embodiment the autorun component 710 checks to see if it is enabled for each media device 820. In one embodiment, the autorun component 710 may access the same list of media devices 899 as that of the media change notification protocol. If the autorun (or autoplay) protocol component 710 is not enabled for any media devices 820 coupled with the computing system 810 then the autorun (or autoplay) protocol component 710 will exit 920 for that device.

Referring now to step 930 of FIG. 9 and to FIG. 8, in one embodiment, if the autorun (or autoplay) protocol component 710 is enabled for the media device 820, then the autorun (or autoplay) protocol component 710 will check to see if the media device 820 is on a list of devices for which the autorun (or autoplay) protocol component 710 is never enabled. If the media device 820 is on the list, then the autorun (or autoplay) protocol component 710 will exit for that device.

Referring now to step 940 of FIG. 9 and to FIG. 8, in one embodiment, if the media device 820 is not on the list of devices for which autorun (or autoplay) protocol component 710 is never enabled, then the autorun (or autoplay) protocol component 710 will begin polling the media device 820 for media 899.

Referring now to step 950 of FIG. 9 and to FIG. 8, in one embodiment, if media 899 is detected (e.g., new media 899, that is, media operating in a media device that has been to this point unrecognized) then a media change notification is output.

### Automatic Execution

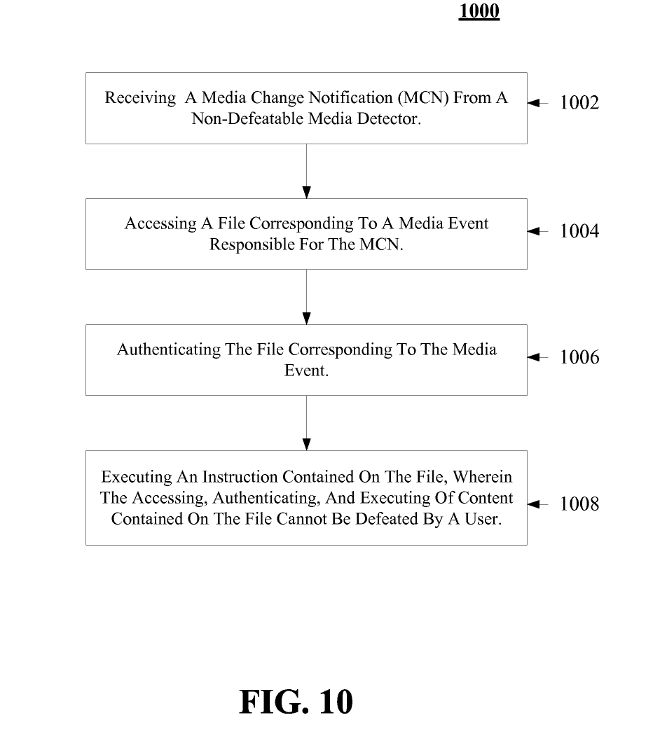

With reference now to FIG. 10, a flowchart of a method for automatically executing an operation after a media event is shown in accordance with one embodiment of the present invention. In general, the method for automatically executing an operation is the second part of the overall method for establishing a non-defeatable autorun (or autoplay) environment within a computer system such as computing system 810 of FIG. 8, and more specifically, in an environment such as the computing environment of FIG. 15.

In one embodiment, as described in detail herein, media content is introduced (e.g., a media event) to a computing system such as computing system 810. The media content may be introduced (or the media event may occur) from a storage device local to the computing system, or the media content may be introduced from a network, such as a local area network (LAN) or the Internet, or the like. Additionally, the media content may be audio, video, or a combination of audio and video. After the media is introduced (e.g., a media event), a media change notification (MCN) is generated, as described herein. Flowchart 1000 commences as the MCN is received by a program on the computing system 810.

With reference now to step 1002 of FIG. 10, a media change notification is received from a non-defeatable media detector such as the media change notification generator described herein when a media event occurs. As described in detail herein, the MCN may be a signal, pulse, application, or the like. The MCN may be system wide or the MCN may be directed to a specific driver, application, component, or the like. In general, the MCN is received by an application, driver, component, or the like (referred to herein as an application for purposes of brevity and clarity). In one embodiment, the application is operating or residing in the background of computing system 810. Moreover, the MCN may be received at the user level, at the kernel level, or at both the user and the kernel level.

Referring now to step 1004 of FIG. 10, in one embodiment, a file corresponding to the media event responsible for the MCN is accessed. For example, when the MCN is received, the application that received the MCN may look for a file with a given file name or at a given file location on the media event (or media). In another embodiment, the application may look for a flag in the content of the media. The flag in the media may be a file name or location that may be used in conjunction with the introduced media. For example, the flag in the media may signal a copyright indicator that may provide copyright information about the media, or actions that may need to be taken due to copyright or other restrictions. In another embodiment, the application may send up a flag informing a second application on computing system 810 of the insertion of media into the computing system 810.

In one embodiment, the media file operates in a manner similar to that of conventional self-installing or self-running program. That is, the activation of the file in the media by the application that received the MCN may activate instructions for installing or running other components immediately upon media insertion. In another embodiment, the file may be empty, indicating that no action is to be performed.

In general, the program file may be in the form of an executable program, a series of system configuration definitions, or a series of directives to find/download/install the latest version of the protective software via the web. Furthermore, the distribution media may contain a library or libraries of files, songs, movies, or other media to protect and may further contain the location information to find the latest version of these libraries. These libraries may be specific to individual copyright holders or hold some more general information that may indicate the rights of a particular class of content (e.g., home user created, public domain, never copy, copy once, copy X times, etc.).

With reference now to step 1006 of FIG. 10, in one embodiment, the file corresponding to the media event are authenticated. That is, after finding the file on the media, the application activated by the MCN will authenticate the file and information contained therein to ensure authenticity. For example, the file may contain instructions, applications, instructions for accessing an application on the computing system 810, accessing applications or instructions on both the media and the computing system 100, directions to access the Internet (e.g., a URL or the like), accessing a dongle (e.g., a PCMCIA card, a parallel port, USB port, biometric, or the like), etc. Thus, the file or instructions thereon may direct the computing system 810 to a plurality of locations for accessing, installing, and/or running an application or applications automatically (e.g., without a users input or guidance). Therefore, it is necessary to authenticate the file and any information contained thereon to ensure that a virus, Trojan, or other illegal application is not being delivered, or initialized on computing system 810.

For example, if copyright protocols are being accessed, the application receiving the MCN may read and establish the copyright protocol file, or portions thereof, to authenticate the inserted media (e.g., authorize one copy, no copies, unlimited copies, or the like). Additionally, the source of the content of the file and the media may be authenticated. For example, the software may be “signed,” encrypted or otherwise protected (e.g., digital certificates, passwords, trusted locations, etc. may be checked to ensure the information being accessed is legitimate) to prevent a malicious software installation including virus, Trojan, false library files, or the like.

This technology could also look for the existence of copyright bits set in a table of contents, a copyright flag within the media, the existence of an encryption method, or a copy protect “file.” Additionally, the software that resides on the computer system 100 may also be signed to prevent removal or modification (e.g., signed drivers, encryption, etc.). For example, multilayer or dual sided disks may be used to store the software protection and libraries therefore allowing for multiple operating system software, multiple versions of the same operating system, and/or large library files. In one embodiment, the software operating on computing system 810 may be installed via one of the plurality of methods described in detail herein. For example, operating system and/or application software upgrades, via bundling with player applications, online installs, bundled with protected media content, written into the operating system, or the like.

Referring now to step 1008 of FIG. 10, in one embodiment, the instructions contained on the file are executed. That is, once the authorization process is complete, the operations specified in the file are executed. For example, the instructions may include the download of a driver or drivers, or the instructions may pertain to copyright issues such as an authorization of a single play, no copy, one copy, etc. Furthermore, the accessing, authenticating, and executing of content contained on the file cannot be defeated, turned off, blocked, overridden, or the like by a user.

Once the steps 1002 through 1008 have been performed, the computing system 810 then returns to operation as normal. That is, the traditional autorun (or autoplay) will or will not occur. For example, if the user has not turned off the autorun feature, any programs or files that are normally run by autorun will occur. However, if the user has turned off the autorun (or autoplay) feature, no programs or files will automatically open. Therefore, unlike traditional user controlled installation mechanisms, the steps 1002 through 1008 cannot be turned off or modified by the user.

Therefore, one embodiment, allows the copyright holder or content manufacturer to provide whatever form of protection they desire for each individual product. Additionally, business rules could also be established regarding the type of protection and the number of copies that may be made of the copyrighted material.

Thus, an advantage of the non-defeatable autorun package is that it does not impose any particular DRM strategy on either the producers or consumers of copyrighted material. It also allows the OS supplier to cooperate with the DRM efforts of the entertainment industry without imposing DRM controls of its own. For example, the method and system described herein allows the media producers to supply and impose whatever protection mechanism, or lack thereof, that they wish. It also allows different products to have different levels of protection, perhaps based on the value of the contents or the pricing of the product. The important point is that the non-defeatable autorun mechanism ensures DRM capabilities but gives individual movie studios and record companies control over the DRM controls of their products. Additionally, the consumer is also given the choice to accept or decline the DRM components, since nothing is installed on the user's computer until the media is actually inserted. Given that different products can have different levels and types of DRM protection, the user can choose those products that offer the most desirable content with the least obtrusive protection.

### Interaction Control

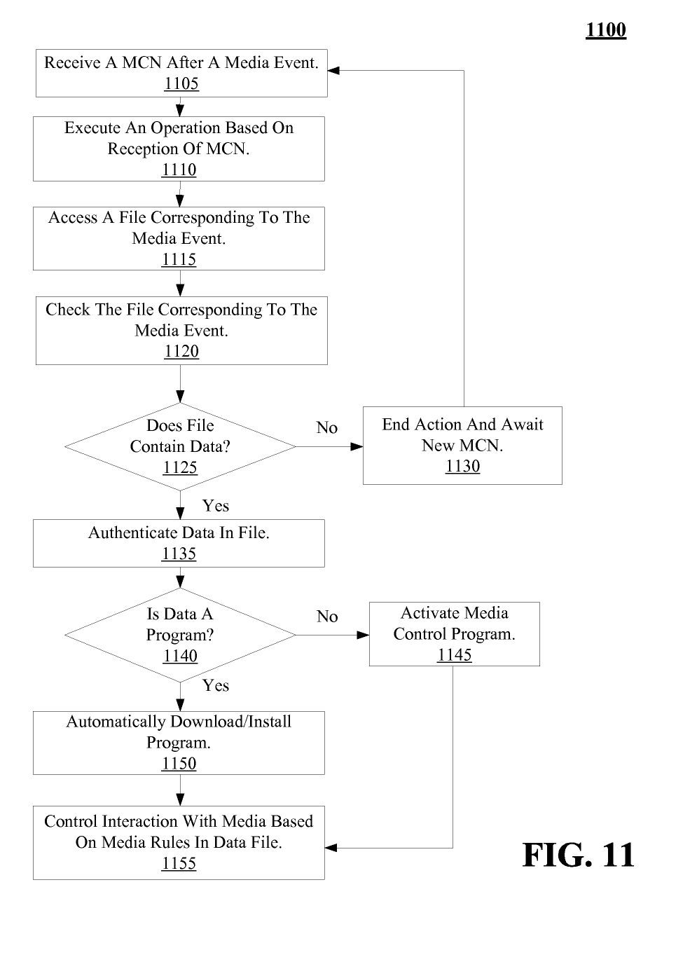

With reference now to FIG. 11, a data flow block diagram for automatically detecting media and implementing interaction control thereon, is shown in accordance with one embodiment of the present invention.

With reference now to 1105 of FIG. 11, in one embodiment a media change notification (MCN) is received after a media event. As described herein, the media event may be a media content introduction from a storage device local to the computing system, or the media content may be introduced from a network, such as a local area network (LAN) or the Internet, or the like. Additionally, the media content may be audio, video, or a combination of audio and video. After the media is introduced (e.g., a media event), a media change notification (MCN) is generated, as described herein.

The media change notification is received from a non-defeatable media detector such as the media change notification generator described herein when a media event occurs. As described in detail herein, the MCN may be a signal, pulse, application, or the like. The MCN may be system wide or the MCN may be directed to a specific driver, application, component, or the like. In general, the MCN is received by an application, driver, component, or the like (referred to herein as an application for purposes of brevity and clarity). In one embodiment, the application is operating or residing in the background of computing system 810. Moreover, the MCN may be received at the user level, at the kernel level, or at both the user and the kernel level.

Referring now to 1110 of FIG. 11, in one embodiment, an operation is executed based on the reception of the MCN. For example, a media change notification is received from a non-defeatable media detector such as the media change notification generator described herein when a media event occurs. As described in detail herein, the MCN may be a signal, pulse, application, or the like. The MCN may be system wide or the MCN may be directed to a specific driver, application, component, or the like. In general, the MCN is received by an application, driver, component, or the like (referred to herein as an application for purposes of brevity and clarity). In one embodiment, the application is operating or residing in the background of computing system 810. Moreover, the MCN may be received at the user level, at the kernel level, or at both the user and the kernel level.

With reference now to 1115 of FIG. 11, in one embodiment, a file corresponding to the media event is accessed. For example, when the MCN is received, the application that received the MCN may look for a file with a given file name or at a given file location on the media event (or media). In another embodiment, the application may look for a flag in the content of the media. The flag in the media may be a file name or location that may be used in conjunction with the introduced media. For example, the flag in the media may signal a copyright indicator that may provide copyright information about the media, or actions that may need to be taken due to copyright or other restrictions. In another embodiment, the application may send up a flag informing a second application on computing system 810 of the insertion of media into the computing system 810.

Referring now to 1120 of FIG. 11, in one embodiment, a file corresponding to the media event is checked. As described herein, the file corresponding to the media event may contain instructions, applications, instructions for accessing an application on the computing system 810, accessing applications or instructions on both the media and the computing system 810, directions to access the Internet (e.g., a URL or the like), accessing a dongle (e.g., a PCMCIA card, a parallel port, USB port, biometric, or the like), etc.

With reference now to 1125 of FIG. 11, in one embodiment, the file is checked for data. If the file does not contain data, then 1130 the action is ended and the system awaits the next MCN. However, if the file does contain data then 1135, the data in the file is authenticated. As described herein, the file or instructions thereon may direct the computing system 810 to a plurality of locations for accessing, installing, and/or running an application or applications automatically (e.g., without a users input or guidance). Therefore, it is necessary to authenticate the file and any information contained thereon to ensure that a virus, Trojan, or other illegal application is not being delivered, or initialized on computing system 810.

For example, if copyright protocols are being accessed, the application receiving the MCN may read and establish the copyright protocol file, or portions thereof, to authenticate the inserted media (e.g., authorize one copy, no copies, unlimited copies, or the like). Additionally, the source of the content of the file and the media may be authenticated. For example, the software may be “signed,” encrypted or otherwise protected (e.g., digital certificates, passwords, trusted locations, etc. may be checked to ensure the information being accessed is legitimate) to prevent a malicious software installation including virus, Trojan, false library files, or the like.

With reference now to 1140 of FIG. 11, in one embodiment, the data in the file is analyzed to establish whether it is information or a program. If the data in the file is information and not a program, then 1145, a media control program (e.g., CCM 100 described in detail herein) is activated. Once the media control program is activated, as described herein, the interaction with the media is controlled based on the media rules in the data file, or on media rules stored in the media control program based on the data received from the data in the file.

Referring now to 1150 of FIG. 11, in one embodiment, if the data in the file is a program, the program is automatically downloaded and/or installed. In another embodiment, the data in the file may be a link to a secondary site that contains the program to be downloaded prior to providing a user access to the rest of the media content on the media event.

With reference now to 1155 of FIG. 11, in one embodiment, interaction with the media is controlled based on the media rules in the data file or the rules linked by the data file on the media, or by data in the media file directed to rules stored outside the media. That is, once the authorization process is complete, the operations specified in the file are executed. For example, the instructions may include the download of a driver or drivers, or the instructions may pertain to copyright issues such as an authorization of a single play, no copy, one copy, etc. Furthermore, the accessing, authenticating, and executing of content contained on the file cannot be defeated, turned off, blocked, overridden, or the like by a user.

Once 1105 through 1155 have been performed, the computing system 810 then returns to operation as normal. That is, the traditional autorun (or autoplay) will or will not occur. For example, if the autorun feature is active, any programs, files or functions that are normally run/performed by autorun will occur. However, if the user has disabled the autorun (or autoplay) feature, no programs or files will automatically be opened by the traditional autorun. However, as described herein, unlike traditional user controlled installation mechanisms, 1105 through 1155 will not be turned off or modified by the user.

Therefore, one embodiment, allows the copyright holder or content manufacturer to provide whatever form of protection they desire for each individual product. Additionally, business rules could also be established regarding the type of protection and the number of copies that may be made of the copyrighted material.

Thus, an advantage of the non-defeatable autorun package is that it does not impose any particular DRM strategy on either the producers or consumers of copyrighted material. It also allows the OS supplier to cooperate with the DRM efforts of the entertainment industry without imposing DRM controls of its own. For example, the method and system described herein allows the media producers to supply and impose whatever protection mechanism, or lack thereof, that they wish. It also allows different products to have different levels of protection, perhaps based on the value of the contents or the pricing of the product. The important point is that the non-defeatable autorun mechanism ensures DRM capabilities but gives individual movie studios and record companies control over the DRM controls of their products. Additionally, the consumer is also given the choice to accept or decline the DRM components, since nothing is installed on the user's computer until the media is actually inserted. Given that different products can have different levels and types of DRM protection, the user can choose those products that offer the most desirable content with the least obtrusive protection.

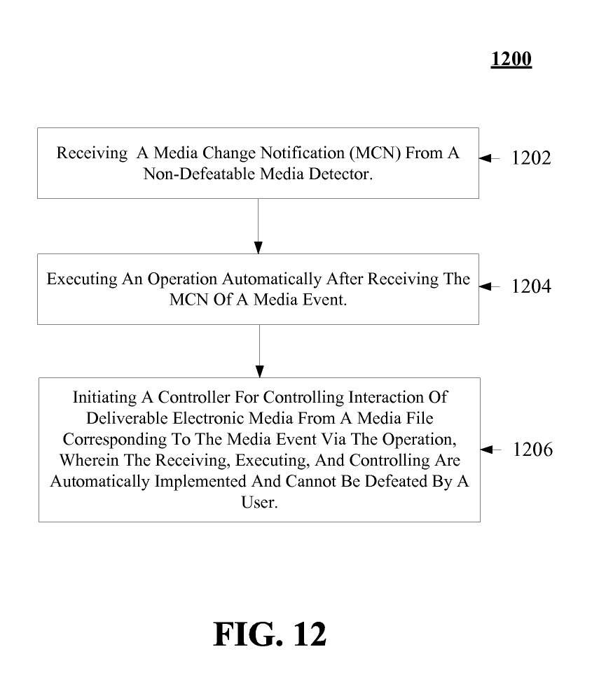

With reference now to FIG. 12, a flowchart of a method for automatically detecting media and implementing interaction control thereon is shown in accordance with one embodiment of the present invention.

Referring now to step 1202 of FIG. 12, in one embodiment, an MCN is received from a non-defeatable media detector. In general operation, the non-defeatable media detector initially poles a media device of a computing system for a media change wherein the polling of the media device cannot be blocked by the computing system. When the non-defeatable media detector detects a media change on the media device a media change notification is generated. Moreover, the media change notification is output to the computing system when the media change is detected.

With reference now to step 1204 of FIG. 12, in one embodiment, an operation is executed automatically after receiving the MCN of the media event. In general, the execution of the operation automatically after the media event includes receiving the MCN from the non-defeatable media detector. In addition, a file is accessed corresponding to the media event responsible for the MCN. The file corresponding to the media event is authenticated, and any instructions contained on the file are executed. In one embodiment, the accessing, authenticating, and executing of the content contained on the file cannot be defeated, stopped, interrupted, or overridden by a user.

As described in detail herein, the content in the file may contain instructions for installing or running other components, e.g., the CCM 100 technology or another copyright compliance mechanism. The instructions may include an executable program, a system configuration definition, a series of system configuration definitions, a directive to find, download, and/or install protection software, or a series of directives to find, download, and/or install protection software. In one embodiment, the instruction is a copyright bits set located in a table of contents, a copyright flag within the media, a copy protect file, or an encryption method.

With reference now to step 1206 of FIG. 12, in one embodiment, a controller for controlling interaction of deliverable electronic media from a media file corresponding to the media event is initiated via the operation, wherein the receiving, executing, and controlling are automatically implemented and cannot be defeated by a user.

In one embodiment, controlling interaction of deliverable electronic media includes detecting a media player application operable with a computer system for enabling the computer system to present contents of a media file. In addition, within the media player application a function that enables non-compliance with a usage restriction applicable to the media file is generated. Moreover, the output of the media file is controlled by a compliance mechanism coupled to the computer system for enabling compliance with the usage restriction applicable to the media file.

In general, the controlling output of the media file includes diverting a data pathway of the media player application to a controlled data pathway controlled by the compliance mechanism. In addition, if no controlling mechanism is present on the computing system, the compliance mechanism can be installed onto the computing system and configured to detect and disable any unauthorized access, copying, uploading, downloading, or the like. In one embodiment, the compliance mechanism installs its own custom media player application on the computing system configured to operate when the user preferred media player application does not comply with usage restrictions detailed in the media file. The compliance mechanism (e.g., CCM 100 or the like) may monitor the media file, the computing system, and any periphery devices during the presentation of the media content for compliance with the usage restrictions.

### Standalone SCMS Compliance

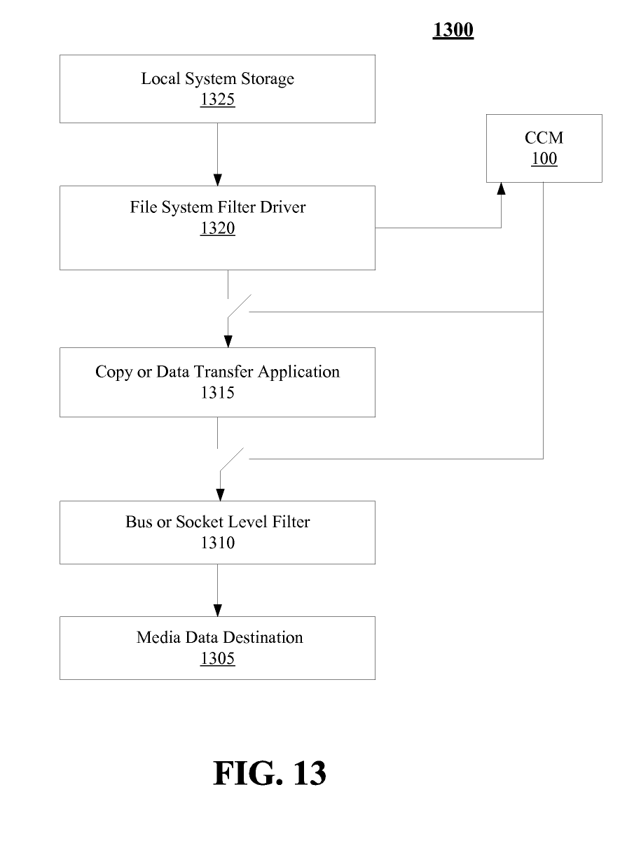

With reference now to FIG. 13 and FIG. 8, a block diagram of a standalone solution for SCMS compliance 1300 when locally stored data is disseminated from a computing system 810 is shown in accordance with one embodiment. In one embodiment, standalone solution for SCMS compliance 1300 utilizes each of the components described and shown in FIGS. 1-9 to provide complete SCMS compliance within any computing system. In another embodiment, standalone solution for SCMS compliance 1300 utilizes one or more of the plurality of components and methods described and shown in FIGS. 1-9 to augment any SCMS capability that may already exists within a system. Furthermore, the standalone SCMS solution 1300 described herein is well suited to being dynamically enhanced to support additional hardware and software device types and media formats, so that the target system remains in compliance over time.

In one embodiment, standalone SCMS system 1300 includes local storage system storage 1325, bus or socket level filter drivers 1310, copy or data transfer application 1315, file system filter drivers 1320, media data destination 1305 and CCM 100. Media data destination 1305 may be any media source such as CD, DVD media 899, portable media, or media received from any source outside of the local system storage 1325 on a computer system 810. For example, media received over a network to a computing system 810. Local system storage 1325 refers to storage such as computer usable memory (ROM) 1504, computer usable volatile memory (RAM) 1503, data storage unit 1505, or the like.

In general, bus or socket level filter driver 1310 refers to one or more drivers utilized for the purpose of monitoring any system buses that support devices or interfaces that can be accessed by means other than the local file system (such as USB devices and storage media accessed using direct SCSI requests). Additionally, in another embodiment, bus or socket level filter driver 1310 may also refer to one or more device-level filters utilized for the purpose of monitoring system devices that are not always active in the system. For example, a storage device supporting removable media will fall into this category, as will devices such as modems and network adapters.

In one embodiment, file system filter driver 1320 refers to one or more drivers utilized for the purpose of monitoring file-based access to files and volumes supported by the target machine.

In one embodiment, CCM 100 is an agent application that manages the various system-level components, uses the information obtained from these components to detect the accesses to SCMS-controlled sources, and enforces copy and/or playback control information that is specified for the source. Such enforcement could include, but is not limited to, the updating of the source to reflect a copy or playback operation, the alteration of a copy of the source to reflect the correct copy and/or playback information as derived from the information in the source, or the blocking of access to a source copying and/or playback is not allowed or if the SCMS information for the source cannot be ascertained or has been corrupted in some way.

The rules of operation for the SCMS system would be similar to those previously described in FIGS. 5 and 6, although these rules may be extended to include copy and playback information at the volume or device level. For example, in one embodiment, copy or playback can be allowed if the source is read-only in nature but marked as freely copyable or playable; however, for read-only sources, access to the source would be denied by default.

In one embodiment, the SCMS information is obtained in an out-of-band fashion. For example, a combination of a unique logical identifier for the source volume or device, and a token of some kind to definitively identify the user may be used by SCMS system 1300 to gain access to copy and playback control information from a local database, Web server, or other external resource.

Moreover, in one embodiment, if the underlying operating system 810 is already fully SCMS-compliant, or becomes fully compliant while the standalone solution for SCMS compliance 1300 is installed, then a mechanism in the standalone solution for SCMS compliance 1300 may detect this condition and will then be able to disable standalone solution for SCMS compliance 1300 operation, severely limit standalone solution for SCMS compliance 1300 operation, or allow the operating system to register itself in a secure manner.

With reference still to FIG. 13 and now to FIGS. 7, 8 and 9, in one embodiment, standalone SCMS compliance system 1300 will use CCM/MSD 700 to provide media or device arrival or removal notifications in the enforcement of copy and playback rights. Moreover, CCM/MSD 700 may utilize autorun protocol 710 to serve as a triggering mechanism to a basic agent application that will then either install or otherwise integrate the executable standalone SCMS compliance system code stored on the incoming volume or device, obtain the executable code from a location specified on the incoming source, or utilize heuristics to determine the nature of the SCMS information for the source and then obtain the executable code through other means (such as download from the Web). CCM/MSD 700 could also act as a “bootstrapper” for the self-contained SCMS solution, working in conjunction with an agent application to obtain and install all of the components needed for the standalone SCMS system 1300.

The following is an example of one embodiment of a user utilizing the standalone SCMS system 1300 to transfer a music file from their system, e.g., computer system 810, to another user over a peer-to-peer network. In general, the user will first launch their peer client software, which would then open the local file from local system storage 1325. Opening the local file would trigger the file system filter driver 1320, which would capture the path to the file being opened, and pass this information to the agent application CCM 100. The CCM 100 would then scan the file for copy control information (or obtain a cached copy of this information from a local database, networked database, remote database, or the like).

If the copyright owner has granted the right to freely copy the file, then CCM 100 will instruct the file system filter driver 1320 to allow the file operation to proceed.

If no copies are allowed for the file, then CCM 100 will indicate to the file system filter driver 1320 that the file operation should be failed with an “access denied” error (or other overt or covert denial of operation). If the user has the right to copy the file in limited fashion, such as described with respect to FIG. 5, then CCM 100 will notify the file system filter driver 1320 that the file operation can continue.

The CCM 100 will then work with the socket level filter driver 1310 to ensure that the outgoing copy of the file is marked to indicate that it is not the original media, and to ensure that the copy control information in the copy conforms to the rights granted by the copyright holder, as described with respect to FIG. 6. If the outgoing transfer operation is successful, the socket level filter driver 1310 will notify the CCM 100 of the completion of the operation, and then modify the copy control information in the original file to indicate that one fewer copy will be allowed (as described with respect to FIG. 6).

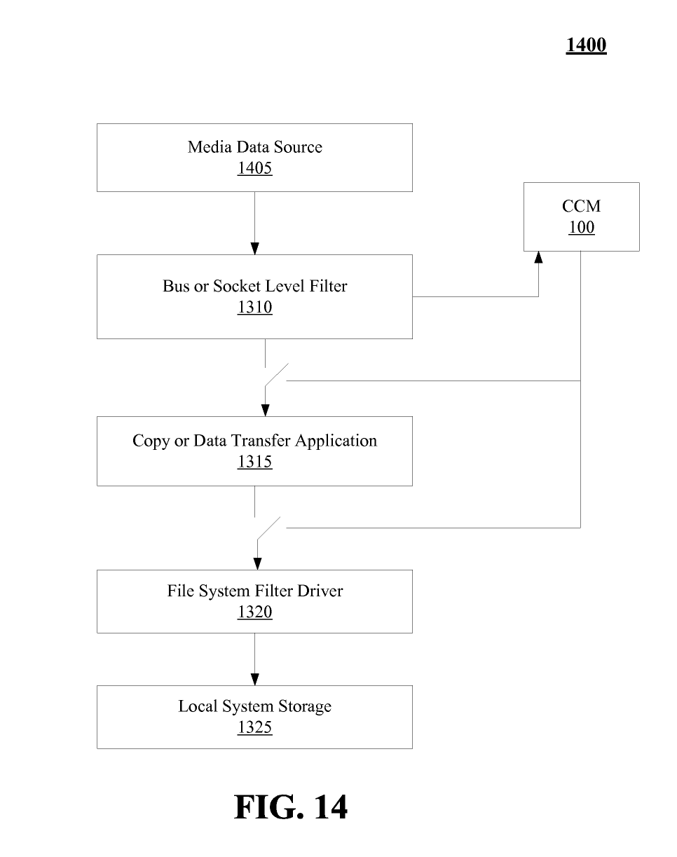

With reference now to FIG. 14 and FIG. 8, a block diagram of a standalone solution for SCMS compliance 1400 when outside data is introduced into a computing system 810 is shown in accordance with one embodiment. In general, standalone solution for SCMS compliance 1400 utilizes similar functionality and components as standalone solution for SCMS compliance 1300 and as such the discussion of the components is not repeated herein for purposes of clarity. However, one difference is the flowchart 1400 beginning by receiving data from a media data source 1405. That is, a source that is outside of the local system.

The following is an example of one embodiment of a user utilizing the standalone SCMS system 1400 to download a file. In one embodiment, the file may be from a music site on the Web. However, the present technology is well suited for any type of media including audio and/or video media. In general, SCMS system 1400 will launch a browser or custom client application, navigate to the desired audio file, and select this file. The socket level filter driver 1310 will monitor the incoming data stream, examine the SCMS information in the audio file, and pass this information to the CCM 100 application. CCM 100 will then forward information about the media file to the file system filter driver 1320, which uses this information to uniquely identify the attempt by the application to open the local file for write access.

If the copyright owner has granted the right to freely copy the file, then the CCM 100 will instruct the file system filter driver 1320 to allow the file operation to proceed. If no copies are allowed for the file, then the CCM 100 will indicate to the file system filter driver 1320 that the file operation should be failed with an “access denied” error (or other overt or covert denial of operation).

If the user has the right to copy the file in limited fashion, such as described with respect to FIG. 5, then the CCM 100 will notify the file system filter driver 1320 that the file operation can continue, but that the SCMS information in the output file should be modified to indicate that it is not the original media, and to ensure that the copy control information in the copy conforms to the rights granted by the copyright holder, as described with respect to FIG. 6. In this case, though, the SCMS information cannot be changed for the original audio file, as it resides on an external resource that is not write-accessible by the local system. As such, CCM 100 will need to either maintain a local copy of the SCMS information for the audio file, or register the copy operation with an external SCMS server. In one embodiment, for subsequent accesses to the file on that site, the CCM 100 may obtain copy control information from the local database, the external SCMS server, or both before determining how to proceed.

Ripping media from a CD or DVD will be similar in nature to downloading media from the Web, except that the bus filter corresponding to the bus 1310 used by the CD/DVD drive will detect the operation rather than the socket level filter driver. Likewise, burning media to a CD or DVD will be similar to transferring media over a peer network, the difference again being that the bus filter will be engaged for the operation instead of the socket level filter. However, in the case of commercial CD or DVD media, the local SCMS compliance system 1300 or 1400 may opt assume by default that copying is not allowed, and thus block all copy operations for these media.

It should be noted that there are other common operations as well, such as copying data to or from an external drive, or to or from a drive on a local network, but for the purpose of this discussion, the technical elements would be essentially the same as for operations that are contained to the target machine. The majority of portable devices fall into this category, such as “smart phones” and portable MP3 players, as these devices will expose their storage to the local system as one or more logical drives.

Note that these examples can also apply to non-media files for which rule-based access control mechanisms have been defined. For example, it may be possible to define a data format for word processing or spreadsheet documents that allows access information to be specified. Such documents can contain not only copy control information, but also information about read and write access, and the users, groups of users, or types of users that are allowed to access the documents.

Thus, in one embodiment, the standalone solution for SCMS compliance is capable of monitoring every operation performed by an application that involves a file, volume, or device containing copy and/or playback control information.

In addition, in one embodiment, the standalone solution for SCMS compliance is capable of managing all forms of SCMS information, including information that may or may not be embedded directly within a particular file, volume or device. Even if such information is supported, there may or may not be a mechanism to update this information to reflect the status of the operation (in the case where the entity supported a limited number of copies or plays). An example of this is a read-only medium such as a CD-ROM, for which the SCMS information could not be modified directly on the medium itself. Also, there may be some file, volume, or device types for which the SCMS information is implied in nature, such as for the copyrighted video content on a commercial DVD.

Furthermore, in one embodiment, the standalone solution for SCMS compliance is able to manage all of the means of access to SCMS-controlled resources including applications that use SCMS-controlled volumes, devices, and files can do so in a number of ways, which include (but again are not limited to) publicly accessible APIs that are documented for the operating system, undocumented APIs, supplemental APIs that use alternate data pathways within a system, lower-level APIs (including those for services at the kernel level), and in some cases, the data bus or the physical hardware itself.

Finally, the standalone solution for SCMS compliance is also capable of monitoring multiplicity of potential data transfer techniques available to the computing system to ensure SCMS compliance. In general, the multiplicity of potential data transfer types include, but is not limited to, file-to-file copy, file-to-rendering-device playback, network-to-file download, and an external-device-to-network upload operation that does not touch the local file system.

### Example Computing System

Referring now to FIG. 15, a diagram of computer system 1500 in accordance with one embodiment of the present invention is shown in greater detail. Within the discussions certain processes are discussed that are realized, in one embodiment, as a series of instructions that reside within computer readable memory units of system 1500 and executed by processor 1502 of system 1500. When executed, the instructions cause the computer system 1500 to perform specific functions and exhibit specific behavior as described.

In general, computer system 1500 used by the embodiments of the present invention comprises an address/data bus 1501 for communicating information, one or more central processors 1502 coupled with the bus 1501 for processing information and instructions, a computer readable volatile memory unit 1503 (e.g., random access memory, static RAM, dynamic, RAM, etc.) coupled with the bus 1501 for storing information and instructions for the central processor(s) 1502, a computer readable non-volatile memory unit 1504 (e.g., read only memory, programmable ROM, flash memory, EPROM, EEPROM, etc.) coupled with the bus 1501 for storing static information and instructions for the processor(s) 1502.

System 1500 also includes a mass storage computer readable data storage device 1505 such as a magnetic or optical disk and disk drive coupled with the bus 1501 for storing information and instructions. Optionally, system 1500 can include a display device 1506 coupled to the bus 1501 for displaying information to the computer user (e.g., maintenance technician, etc.), an alphanumeric input device 1507 including alphanumeric and function keys coupled to the bus 1501 for communicating information and command selections to the central processor(s) 1502, a cursor control device 1508 coupled to the bus for communicating user input information and command selections to the central processor(s) 1502, and a signal generating input/output device 1509 coupled to the bus 1501 for communicating command selections to the processor(s) 1502.

Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

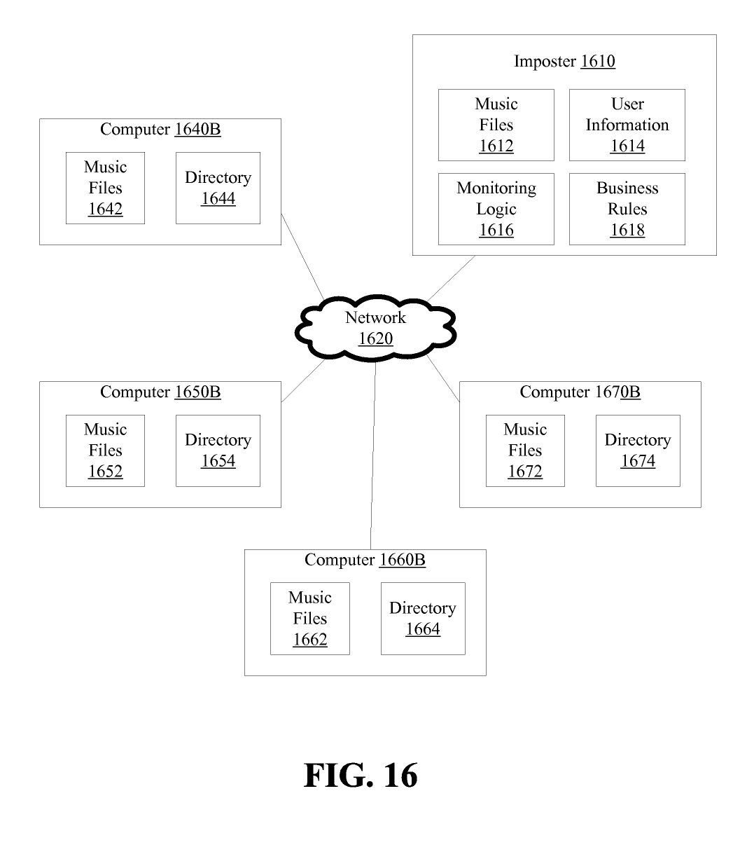

FIG. 16 is a block diagram of an exemplary system that may be used for protecting copyrighted media with monitoring logic that may be used for reporting information about users who illegally obtain copyrighted media, according to embodiments of the invention. The blocks in FIG. 16 can be arranged differently than as illustrated, and can implement additional or fewer features than what are described herein.

FIG. 16 includes user computers (e.g., 1640B, 1650B, 1660B, and/or 1670B) and a computer called imposter 1610, as will be described in more detail. Computers 1640B, 1650B, 1660B, and/or 1670B and imposter 1610 communicate over network 1620. According to one embodiment, imposter 1610 may be one or more servers that are coupled with network 1620. The computers 1640B, 1650B, 1660B, and/or 1670B may be associated with a P2P network that is either currently associated with a service provider that illegally trades music or may be associated with a service provider that was shutdown by the law because it was illegally trading music. Imposter 1610 includes music files 1612 that can be traded among the computer devices (e.g., 1650B, 1660B, and/or 1670B), monitoring logic 1616 for monitoring the access of the music associated with music files 1612, user information 1614 for storing information about the users (e.g., users of computers 1640B, 1650B, 1660B and/or 1670B) associated with the P2P network, and business rules 1618.

Frequently, only about 10% of the computers of a P2P network are point sources. One approach to stopping the illegal trading of copyrighted media in a P2P network involves setting a trap for users (e.g., users of computers 1640B, 1650B, 1660B and/or 1670B) and then later springing the trap. For example, using a computer, for example, that impersonates a service provider (referred to hereinafter as an “imposter service provider”) or a user (referred to hereinafter as an “imposter user 1610”) that provide lot of high quality music using music files 1612. Since the imposter 1610 provides high quality music, word gets around, and users of computers 1640B, 1650B, 1660B and/or 1670B start requesting music from this imposter 1610.

Point sources may play a role in setting up the trap since they distribute a large amount of the illegally traded music to other computers in a P2P network. For example, since point sources, such as computer 1640B, trade a large volume of illegal music with other computers (e.g., 1650B, 1660B and/or 1670B) in a P2P network, the trading of this music may be used as a vehicle for setting a trap for a point source, such as computer 1640B, as well as the other computers, as will be described in more detail.

Within FIG. 16, as the users (e.g., users of computers 1640B, 1650B, 1660B and/or 1670B) request the music, the imposter 1610 may obtain user information, such as email addresses, Internet Protocol (IP) addresses, Media Access Control (MAC) addresses, home addresses, names of the users, etc. and store the information about the users (e.g., users of computers 1640B, 1650B, 1660B and/or 1670B) in user information 1614.

Once user information for enough users has been obtained, the trap may be sprung. For example, the user information 1614 may aid in prosecuting offenders. Warning messages may be sent out to the offenders' computers (e.g., 1640B, 1650B, 1660B, and/or 1670B) using their email addresses and/or letters sent to their home addresses, for example. The point sources may especially be targeted since they played a key role in trading high volumes of illegally obtained music.

One way of obtaining information about the users (e.g., users of computers 1640B, 1650B, 1660B and/or 1670B) in a P2P network is to require the users to register before they can obtain music associated with music files 1612. For example, while registering, the users may be required to provide their names, addresses, email addresses, etc. A second way of obtaining information about the users in a P2P network is to require the users to install software, such as monitoring logic 1616 onto their computers (e.g., 1640B, 1650B, 1660B and/or 1670B), that may be required to play, e.g., access, the music from music files 1612 obtained from the imposter 1610, according to one embodiment.

According to another embodiment, monitoring logic 1616 (FIG. 16) may be installed on a user's computer (e.g., 1640B, 1650B, 1660B and/or 1670B) for the purposes of detecting the presence of music on the user's computer. For example, the music may be detected as a result of music from music files 1612 being accessed. The music may be accessed, for example, when it is played, copied, and/or transmitted to a user's computer, among other things. The monitoring logic 1616 may be installed either with the cooperation of the music service providers or without their cooperation.

Once the presence of the music has been detected on a user's computer (e.g., 1640B, 1650B, 1660B, and/or 1670B), the music may be analyzed either locally on the computer (e.g., 1640B, 1650B, 1660B, and/or 1670B) where the monitoring logic 1616 has been installed and/or remotely on another computer, such as imposter 1610, to determine if the music is copyrighted. Actions may be taken based on business rules 1618, as will be described in more detail. According to one embodiment, an “authorization server” may be used for authorizing the access of music. In this case, imposter 1610 may be an authorization server. The music may be accessed, for example, by playing the music, copying the music, and/or transmitting the music, among other things.

Monitoring logic 1616 may be associated with media player/recorder applications, codecs, and/or filters. Examples of filters include, but are not limited to, Internet Protocol (IP) filters and/or Ethernet filters that monitor the transmission of music from and to communication ports, for example. For example, the applications for companies that illegally trade copyrighted media use well known ports. Users may be tricked into installing a filter on their computers (e.g., 1640B, 1650B, 1660B, and/or 1670B) that monitors the activities on these ports. In another example, a filter may be associated with a file system (referred to hereinafter as a “file system filter”) to monitor the music associated with the file system, using techniques described herein.

Within FIG. 16, numerous methods may be used for installing monitoring logic 1616 on a user's computer (e.g., 1640B, 1650B, 1660B, and/or 1670B). For example, the monitoring logic 1616 could be installed with the cooperation of service providers. If the music service provider cooperates, the monitoring logic 1616 may be distributed as a part of the service provider's media player/recorder application.

However, if the music service providers do not cooperate, the monitoring logic 1616 may be transferred to the computers (1640B, 1650B, 1660B and/or 1670B) of unsuspecting users while transmitting music files 1612 to the computers (1640B, 1650B, 1660B and/or 1670B). For example, when a user requests a particular music file from the music files 1612 associated with imposter 1610, the monitoring logic 1616 may be transferred to the unsuspecting user's computer (e.g., 1640B, 1650B, 1660B, and/or 1670B) along with the particular music file. Similarly, once the monitoring logic 1616 has been transferred to a particular computer, such as a point source like computer 1640B, a copy of the monitoring logic 1616 may be transferred from computer 1640B to computer 1650B, 1660B and/or 1670B. For example, the user of computer 1670B may obtain music from computer 1640B. When the music file is transmitted from computer 1640B to computer 1670B, a copy of the monitoring logic 1616 that is installed on computer 1640B may be transferred with a music file from the music files 1642 associated with computer 1640B. The monitoring logic 1616 may be transmitted with the music files (e.g., 1612, 1642, 1652, 1662, and/or 1672) to unsuspecting users by “piggybacking” the monitoring logic 1616 on the music files (e.g., 1612, 1642, 1652, 1662, and/or 1672).

Within FIG. 16, other mechanisms may be used for installing monitoring logic 1616 on users' computers (e.g., 1640B, 1650B, 1660B, and/or 1670B). In one example, the users may be enticed to obtain files that include applications the users are interested in like a new web game, a digital video disk (DVD), a utility of some sort, a chat program, a calendar that can be shared with other users, etc. The monitoring logic 1616 may be transferred to the users' computers (e.g., 1640B, 1650B, 1660B, and/or 1670B) along with the files the users obtained. In a second example, the monitoring logic 1616 may be installed on the users' computers (e.g., 1640B, 1650B, 1660B, and/or 1670B) when they register or setup an account with an imposter user or an imposter service provider (e.g., 1610) to obtain one or more music files 1612. In a third example, the users may download the monitoring logic 1616 from a Uniform Resource Locator (URL). In this case, the music from music files 1612 may not be playable without a new media player/recorder application or a new codec (e.g., monitoring logic 1616). The user may then be motivated to go to a URL and download the new media player/recorder application or the new codec (e.g., monitoring logic 1616) onto their computer.

Once the monitoring logic 1616 is installed on a user's computer (e.g., 1640B, 1650B, 1660B, and/or 1670B), the monitoring logic 1616 may be used to detect the presence of music on the user's computer. The music may be analyzed, for example, to determine if it is copyrighted. The entire music, portions of the music, or information about the music may be compared to a list of music to determine if the music is copyrighted. Examples of information about the music include the name of the music, the size of a file that includes the music, or a signature of the music, among other things. Lists of music may be implemented as lists in text files, tables, and/or databases, among other things.

Within FIG. 16, signatures of music can involve analyzing the music for patterns that uniquely identify the music. Signatures may be computed using well known techniques in the art. Signatures may be computed based on the entire music or on a portion of the music. One example of computing a signature involves analyzing the music or a portion of the music to determine the decimal levels associated with the music or the portion of the music. In a second example, a signature may be calculated by performing a hash function on the music or a portion of the music. In a third example, a signature may be computed by analyzing peaks and valleys in the volume of the music or a portion of the music. In this case, specific frequencies or groups of frequencies or cumulative frequencies may be used in computing a signature.

According to one embodiment, if a recognizable signature is not found, then another portion of the song may be analyzed to try to find a recognizable signature. Different portions of the music may be used to compute a signature until a determination is made as to whether the music is copyrighted. A determination of whether the music is copyrighted may be made by comparing a signature of the music with signatures of music associated with the list of music already described herein. The computation of signatures and/or using the signatures to determine if the music is copyrighted may be performed by monitoring logic (e.g., 1616) that is installed on a user's computer (e.g., 1640B, 1650B, 1660B, and/or 1670B) or by another application, or partly by monitoring logic and partly by the application. The application may execute on a computer that is separate from a user's computer (e.g., 1640B, 1650B, 1660B, and/or 1670B), such as a server.

Within FIG. 16, users may try to prevent monitoring logic 1616 from monitoring the activities on the users' computers (e.g., 1640B, 1650B, 1660B, and/or 1670B) by changing the extension of their respective music files (e.g., 1642, 1652, 1662, and/or 1672) to extensions typically associated with non-music types of files, such as “.doc.” However, according to one embodiment, the monitoring logic 1616 may analyze information in the headers of the files (e.g., 1642, 1652, 1662, and/or 1672) to determine that the files (e.g., 1642, 1652, 1662, and/or 1672) contain media, such as music.

If the music is copyrighted, one or more actions may be taken based on business rules 1618. Examples of actions can include reporting user information to a computer, such as imposter 1610, reporting information about the music to a computer, such as imposter 1610, modifying the music, denying authorization to access the music, not allowing the transmission of the music, etc.

Examples of modifying the music can include, among other things, encrypting the music, adding gaps of silence to the music, adding hissing noises to the music, and modifying the volume of the music. The music may be encrypted, for example, with information, such as a MAC address, that is only associated with the computer that was authorized to access the music (referred to hereinafter as “local encryption”). According to one embodiment, Cactus Data Shield (CDS) can be used to encrypt the music or other types of media.

Within FIG. 16, one or more actions may be performed upon detection of the presence of the music on the user's computer (e.g., 1640B, 1650B, 1660B, and/or 1670B). For example, the presence of the music on a user's computer may be detected when the music is being downloaded onto the user's computer. The music may then be modified (e.g., an action), for example, by introducing gaps or binary zeros into the middle of the music upon detecting that the music is being downloaded. Alternatively, one or more actions may be taken at a future point in time from when the presence of the music is detected. Continuing the example, although the presence of the music may be detected when it is being downloaded onto a user's computer, the music may be modified at some later time (e.g., a few months) after the music was downloaded.

Business rules 1618 may specify what actions may be taken, such as the actions already described herein. Further, business rules 1618 may be used to specify when actions are taken. For example, the business rules 1618 may specify that an authorization server may allow music in the P2P network to be accessed, for example by playing the music for some period of time, such as for three months, thereby allowing time for unsuspecting users to trade the music among themselves. Monitoring logic (e.g., 1616) that has been installed on the users' computers (e.g., 1640B, 1650B, 1660B, and/or 1670B) may invoke the authorization server, for example, when the music is accessed. Then based on the business rules 1618, the authorization server may no longer allow the music to be played (e.g., accessed).

Within FIG. 16, monitoring logic 1616 may be installed as software and/or hardware on any device that is capable of accessing music and/or media, such as a personal computer (PC), a laptop, a player/record, and a mobile device, among other things. Player/recorders may be digital, such as MP3 players. Examples of mobile devices include MP3 players, laptops, mobile phones, and portable computing devices, among other things.

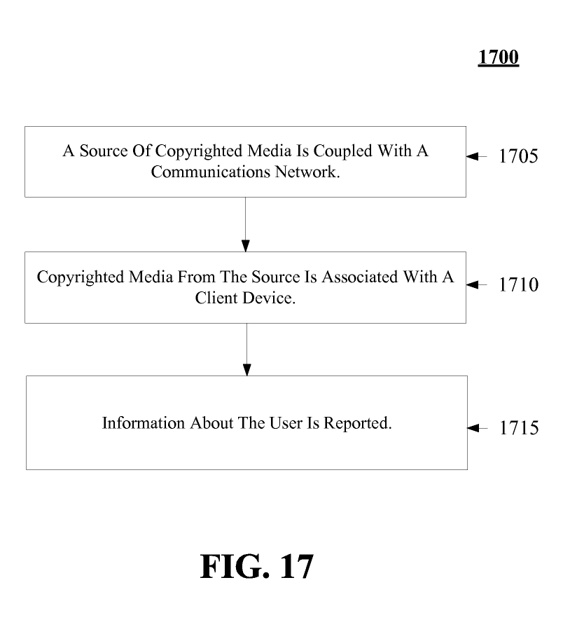

FIG. 17 is a flowchart of a method 1700 for reporting information about users who obtain copyrighted media illegally or in an unauthorized manner using a network according to embodiments of the invention. For the purposes of illustration, the structures depicted in FIG. 16 shall be referred to in describing the method 1700 depicted in FIG. 17.

In operation 1705, a source of copyrighted media is coupled with a communication network, according to one embodiment. For example, a computer, such as imposter 1610, that provides high quality copyrighted music (e.g., music files 1612) is coupled with a communication network by an imposter service provider or an imposter user.

At operation 1710, copyrighted media from the source is associated with a client device (e.g., computer), according to an embodiment. For example, computers (e.g., 1640B, 1650B, 1660B and/or 1670B) start requesting the MP3s from the imposter 1610's music files 1612. When the computers request the MP3s, they may also obtain a copy of monitoring logic 1616 with a media player/recorder application for playing the MP3s. In one example, the media player/recorder application may be piggy backed on the particular file that includes the requested MP3. In a second example, the users may obtain the media player/recorder application by going to a particular URL and requesting the media player/recorder application. In a third example, the users may be required to register to obtain the MP3s and then the media player/recorder application may be transmitted to the users as a part of their registering.

In operation 1715, information about the user is reported, according to an embodiment. For example, information about users of the downloading computers (e.g., 1640B, 1650B, 1660B and/or 1670B) may be reported to imposter 1610 and stored in user information 1614 in the case where the users are required to register. In a second example, user information may be reported to imposter 1610 and stored in user information 1614 when the users of the downloading computers go to play the MP3s. In this case, the media player/recorder application may detect when a user requests that the computer play a particular MP3 and cause actions to be taken, such as reporting user information to imposter 1610. In this case, imposter 1610 may be an authorization server that the media player/recorder application communicates with each time the music and/or media is played.

If a computer transmits the MP3's to another computer, these other computers will need to obtain a copy of the media player/recorder application so they can play the MP3s. When the other computers play the MP3s, the media player/recorder applications may also obtain user information about the users of these computers.

After a period of time, an authorization server may cause the MP3s to be unplayable. Business rules 1618 may specify a period of time that the MP3s may be played. The user information 1614 may be used to notify and convict users of their crimes.

The media player/recorder application may locally encrypt the MP3 so that the MP3 can only be played on a particular user's computer (e.g., 1640B, 1650B, 1660B, and/or 1670B). The media player/recorder application may also decrypt the MP3 so that it can be played. If the computer transmits the MP3 to another computer, the other computer will not be able to play the MP3 because the MP3 was locally encrypted so it can only be played on the original computer.

Method 1700 may be implemented with more or less operations than the operations depicted in FIG. 17.

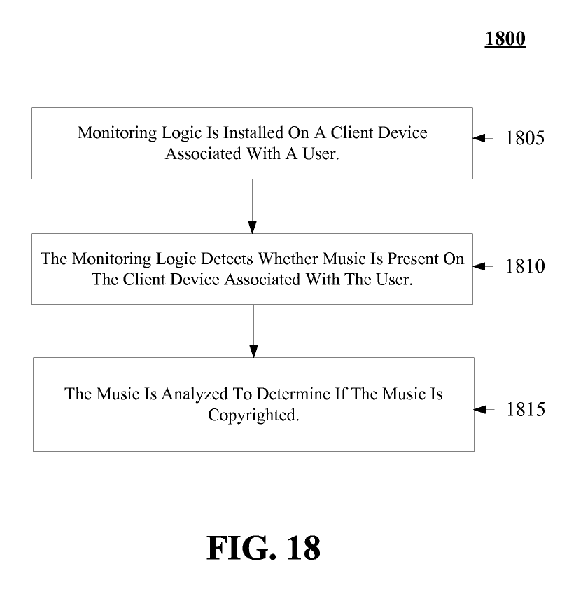

FIG. 18 is a flowchart of a method 1800 for protecting copyrighted media using monitoring logic that detects the presence of copyrighted media on a computer, according to embodiments of the invention. For the purposes of illustration, the structures depicted in FIG. 16 shall be referred to in describing the method 1800 depicted in FIG. 18.

At operation 1805, monitoring logic (e.g., 1616) is installed on a client device, such as a computer (e.g., 1640B, 1650B, 1660B, and/or 1670B) associated with a user, according to one embodiment. For example, the user of computer 1640B likes to obtain illegal music from an application that uses port X from company A. Company B owns the copyright to the music that company A is illegally distributing. The user of computer 1640B may be tricked by company B into installing monitoring logic, such as an IP filter or an Ethernet filter, onto his computer 1640B using techniques already described herein, in order to set a trap for the user of computer 1640B and for the other users (e.g., users of computers 1650B, 1660B and/or 1670B). For example, company B may advertise a new web game on the Internet that the user of computer 1640B sees while searching the Internet. The user of computer 1640B may download the web game onto his computer 1640B. Without his knowledge an IP/Ethernet filter is transmitted with the web game and installed on his computer 1640B when he installs the web game.

At operation 1810, the monitoring logic (e.g., 1616) detects whether music is present on the computer associated with the user, according to one embodiment. For example, the IP/Ethernet filter monitors all activities on port X and therefore can detect when computer 1640B obtains music from company A.

At operation 1815, the music is analyzed to determine if the music is copyrighted, according to one embodiment. For example, the IP/Ethernet filter, or some other application, may analyze the music to determine if it is copyrighted. Continuing the example, assume that computer 1640B obtains a particular piece of music from company A. The IP/Ethernet filter detects when the piece of music comes across port X associated with computer 1640B. The IP/Ethernet filter may transmit a copy of the music to an application that company B has written. The application can analyze the music to determine if it is copyrighted, for example, by analyzing the entire copy, by analyzing a portion of the copy, by deriving a signature for the music, and comparing the entire copy, a portion, or the signature to a list of music using techniques already described herein.

Further, the IP/Ethernet filter may obtain user information, such as the IP address of computer 1640B, computer 1640B's MAC address, the email address for computer 1640B, etc. The IP/Ethernet filter may even be able to obtain the home address for the user of computer 1640B by searching information on computer 1640B. The user information may be reported to imposter 1610 and stored in user information 1614.

To prevent the user of computer 1640B from providing music that he obtained in an unauthorized or illegal manner from company A to other computers (e.g., 1650B, 1660B, and/or 1670B), a codec may be downloaded with the web game and installed on computer 1640B without the knowledge of computer 1640B's user. The first time computer 1640B plays the music, the codec may encrypt the music so that it can only be played on computer 1640B. For example, the codec may locally encrypt the music with the MAC address of computer 1640B. The codec may also decrypt the music using computer 1640B's MAC address when computer 1640B plays the music. Since the music is locally encrypted, if computer 1640B provides the music to another computer, such as computer 1650B, computer 1650B will not be able to play the music.

In another embodiment, the IP/Ethernet filter on computer 1640B may modify the music by introducing gaps, changing the volume, or somehow making the music undesirable or less desirable, among other things, to someone listening to it.

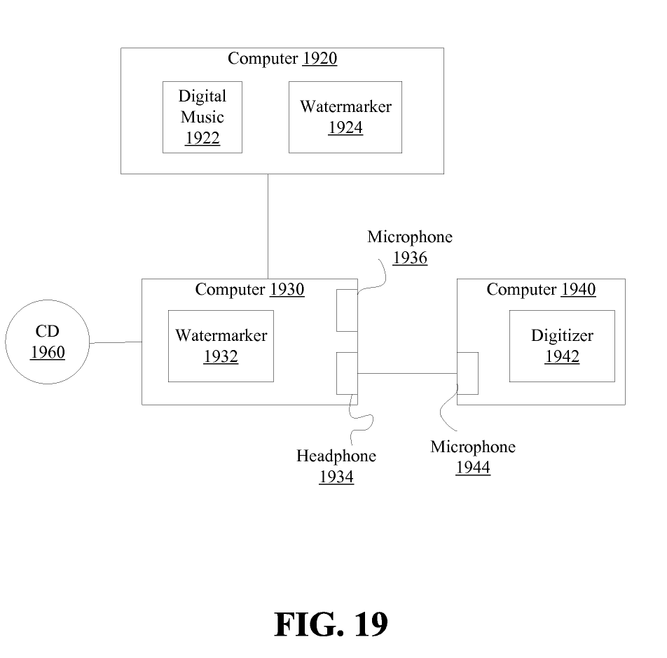

FIG. 19 is a block diagram of a system that uses watermarking techniques to prevent users from circumventing monitoring logic, according to embodiments of the invention. According to one embodiment, watermarking techniques, which are well known in the art, can be used to prevent users from circumventing monitoring logic by converting digital music into analog music. For example, a computer 1930 may receive digital music 1922 from a computer 1920 or from an electronic device readable medium, such as a compact disk (CD) 1960. The digital music 1922 may be watermarked by a watermarker, such as watermarker 1924, prior to being transmitted to computer 1930 in such a way that indicates it is copyrighted. Similarly, the music on the CD 1960 may be watermarked indicating that it is copyrighted. For example, the music may be watermarked using Secure Digital Music Initiative (SDMI) technology. The computer 1920 may be associated with a real service provider, an imposter service provider or an imposter user, among other things.

If the digital music 1922 or CD 1960 is not watermarked, computer 1930 may determine if the music is copyrighted using techniques already described herein, for example when the music is downloaded onto computer 1930, played on computer 1930, copied or re-recorded by computer 1930, or transmitted by computer 1930 to another computer 1940. In this case, computer 1930 may watermark the music with a watermarker 1932. The watermarker 1932 may be associated with a filter, codec, or media player/recorder application that has been installed on computer 1930 using techniques already described herein.

Within FIG. 19, an analog version of the music may be transmitted out of computer 1930 from the head phone connection 1934 into the microphone connection 1944 of another computer 1940. The music may be re-digitized by computer 1940 at digitizer 1942. Monitoring logic (e.g., 1616) associated with computer 1940 may be used to determine that the music is watermarked and take appropriate actions. The monitoring logic may have been installed on computer 1940 using techniques already described herein. Computer 1940 may use watermarking technology, such as SDMI technology, to determine that the music was watermarked.

The actions that computers 1930 and/or 1940 may take include, but are not limited to, reporting the presence of the music to a server, modifying the music to make it less desirable or unplayable, denying authorization to play the music, not allowing the transmission or the copying of the music, etc., and/or using techniques already described herein.

In a second example, computer 1930 of FIG. 19 may transmit the music from its headphone output 1934 back into its own microphone input 1936. In this case, monitoring logic (e.g., 1616) of computer 1930, as already described herein, may use watermarking technology to determine that the music was watermarked. In a third example, computer 1930 may transmit the music from its headphone output 1934 to a microphone associated with a digital media player/recorder, such as an MP3 player. Monitoring logic (e.g., 1616) may be a part of the MP3 player, for example, in the form of SDMI technology.

Although a number of embodiments have been described in terms of music, aspects described herein may be used for any form of media, such as music, movies, videos, DVDs, CDs, books, documents, graphics, etc.

Although “accessing” has been defined in terms of playing music, transmitting music, copying music, etc., “accessing” may also included displaying copyrighted media, for example, in the case of movies, DVDs, books, graphics, and documents.

Although many of the embodiments of the invention and scenarios pertained to unlawfully obtaining media, such as music, the embodiments of the invention and/or the scenarios may also pertain to obtaining media when the user is not unauthorized to obtain the media.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

What is claimed is:

1. A computer readable medium having computer implementable instructions stored thereon, said instructions for causing a compliance mechanism to perform a method for standalone serial copy management system (SCMS) compliance with respect to distributing protected digital media from a computing system, said method comprising:
utilizing a file system filter to alert a copyright compliance mechanism (CCM) when a digital media file is selected for transfer from a local storage system of said computing system to another device, said CCM accessing serial copy management system copy/playback information for said digital media file;
said CCM allowing said file system filter to utilize a common transfer pathway for said digital media file to said another device if said serial copy management system copy/playback information comprises free copy/playback information; and
said CCM directing said file system filter to utilize a new pathway distinct from said common transfer pathway if said transfer of said digital media file is controlled according to said serial copy management system copy/playback information.

2. The computer readable medium of claim 1 further comprising:
utilizing said new pathway to bypass a copy or data transfer application of said operating system.

3. The computer readable medium of claim 1 further comprising:
validating said serial copy management system copy/playback information.

4. The computer readable medium of claim 1 further comprising:
utilizing said serial copy management system copy/playback information to determine if a secure copy and playback application is authorized to generate and transfer a copy of said digital media file; and
transferring said digital media file to said another device if said transfer is authorized by said serial copy management system copy/playback information for said digital media file.

5. The computer readable medium of claim 4 further comprising:
utilizing a custom media library linked with a CCM-enabled playback/recording/transfer application via said new pathway distinct from a commonly used data pathway instead of a commonly used copy or data transfer application, such that said digital media file continuously remains in a secure environment during said transfer.

6. The computer readable medium of claim 5 further comprising:
directly linking said custom media library with said CCM-enabled playback/recording application such that said custom media library is hard linked into said CCM-enabled playback/recording/transfer application.

7. The computer readable medium of claim 1 further comprising:
utilizing said new pathway to provide said digital media file to be transferred from a CCM-enabled playback/recording/transfer application to a bus or socket level filter.

8. The computer readable medium of claim 1 further comprising:
updating said serial copy management system copy/playback information of said digital media file to reflect said transferring.

9. The computer readable medium of claim 1 further comprising:
including at least a reference to said serial copy management system copy/playback information of said digital media file with a transferred digital media file such that said serial copy management system copy/playback information of said transferred digital media file correlates to and correctly provides said serial copy management system copy/playback information of said digital media file in said local storage.

10. A standalone serial copy management system (SCMS) compliance system comprising:
a file system filter driver for alerting a copyright compliance mechanism (CCM) when a digital media file is selected for transfer from a local storage system of a computing system to another device;
said CCM accessing serial copy management system copy/playback information for said digital media file;
a common transfer pathway for transferring said digital media file to said another device if said serial copy management system copy/playback information comprises free copy/playback information; and
a new pathway distinct from said common transfer pathway to redirect said digital media file from said file system filter to said CCM when said digital media file is controlled according to said serial copy management system copy/playback information.

11. The stand alone SCMS compliance system of claim 10 wherein said new pathway initially bypasses a copy or data transfer application of said operating system and is provided to a bus or socket level filter from within the secure CCM.

12. The stand alone SCMS compliance system of claim 10 further comprising:
a bus or socket level filter for alerting said CCM when a second digital media file is to be received from said another device to said computing system;
said CCM accessing serial copy management system copy/playback information for said second digital media file;
said common transfer pathway for receiving said second digital media file to said computer system if said serial copy management system copy/playback information comprises free copy/playback information; and
said new pathway distinct from said common transfer pathway to redirect said digital media file from said bus or socket level filter to said CCM when said digital media file is controlled according to said serial copy management system copy/playback information.

13. The stand alone SCMS compliance system of claim 12 wherein said new pathway initially bypasses said copy or data transfer application of said operating system and is provided to said file system filter driver from within the secure CCM.

14. The stand alone SCMS compliance system of claim 10 further comprising:
a custom media library linked with a CCM-enabled playback/recording/transfer application via said new pathway for continuously maintaining said digital media file in a secure environment during said transfer, said CCM-enabled playback/recording/transfer application comprising:
a validator for validating said serial copy management system copy/playback information; and
a serial copy management system copy/playback information verifier for verifying said serial copy management system copy/playback information authorizes said SCMS compliance system to generate and transfer a copy of said digital media file.

15. The stand alone SCMS compliance system of claim 10, further comprising:
a source file receiver receiving a source file of said digital media file, said source file having (n) copy and (n) playback management information associated therewith;
a destination file generator generating a destination file based on said source file of said digital media file said destination file having (0) copy and (n) playback management information associated therewith;
a modified source file generator generating a modified source file based on said source file of said digital media file said modified source file having (n−1) copy and (n) playback management information associated therewith; and
a validator validating said destination file and said modified source file based on said source file of said digital media file.

16. A computer readable medium having computer implementable instructions stored thereon, said instructions for causing a compliance mechanism to perform a method for standalone serial copy management system (SCMS) compliance with respect to receiving protected digital media to a computing system, said method comprising:
utilizing a bus or socket level filter to alert a copyright compliance mechanism (CCM) when a digital media file is to be received from another device to said computing system, said CCM accessing serial copy management system copy/playback information for said digital media file;
said CCM allowing said bus or socket level filter to utilize a common transfer pathway for receiving said digital media file from said another device if said serial copy management system copy/playback information comprises free copy/playback information; and
said CCM directing said bus or socket level filter to utilize a new pathway distinct from said common transfer pathway if said digital media file is controlled according to said serial copy management system copy/playback information.

17. The computer readable medium of claim 16 further comprising:
validating said serial copy management system copy/playback information; and
utilizing a custom media library hard linked with a CCM-enabled playback/recording/transfer application via said new pathway distinct from a commonly used data pathway, such that said digital media file continuously remains in a secure environment during said transfer; and
utilizing said new pathway to provide said digital media file to be received from a CCM-enabled playback/recording/transfer application to a file system filter driver.

18. The computer readable medium of claim 16 further comprising:
utilizing said serial copy management system copy/playback information to determine if said computing system is authorized to receive a copy of said digital media file; and
receiving said digital media file from said another device if said copy of said digital media file is authorized by said serial copy management system copy/playback information.

19. The computer readable medium of claim 16 further comprising:
updating said serial copy management system copy/playback information of said digital media file to reflect said receiving of said digital media file.

20. The computer readable medium of claim 16 further comprising:
including at least a reference to said serial copy management system copy/playback information of said digital media file with said copy of said digital media file sent such that said serial copy management system copy/playback information of said original digital media file correlates to and correctly provides said serial copy management system copy/playback information of said received digital media file.
